(19) United States
(12) Patent Application Publication
(10) Pub. No.: US 2011/0220428 A1
(43) Pub. Date: Sep. 15, 2011

(54) HYBRID DRIVE DEVICE

(75) Inventor: Masahiko ANDO, Nagoya (JP)

(73) Assignee: AISIN AW CO., LTD., Anjo-shi (JP)

(21) Appl. No.: 12/958,654

(22) Filed: Dec. 2, 2010

(30) Foreign Application Priority Data
Mar. 9, 2010 (JP) 2010-051866

(51) Int. Cl. B60K 6/50; B60K 6/42; B60K 6/46; B60K 6/38

(52) U.S. Cl. 180/65.245; 180/65.22; 180/65.21; 903/902

(57) ABSTRACT

A hybrid drive device configured with an input member coupled to an internal combustion engine, a first rotating electrical machine, a second rotating electrical machine, an output member drivingly coupled to wheels and the second rotating electrical machine; and a differential gear unit. A first rotating element of the differential gear unit is drivingly coupled to the first rotating electrical machine. A second rotating element is drivingly coupled to the input member. A third rotating element is selectively fixed to a non-rotating member by a rotating restricting device. A fourth rotating element is selectively drivingly coupled to the output member via a rotational direction restricting device. Accordingly, the rotational direction restricting device is provided so as to allow the output member to rotate only in a positive direction relative to the fourth rotating element of the differential gear unit.

### INCORPORATION BY REFERENCE

The disclosure of Japanese Patent Application No. 2010-051866 filed on Mar. 9, 2010 including the specification, drawings and abstract is incorporated herein by reference in its entirety.

### BACKGROUND OF THE INVENTION

The present invention relates to hybrid drive devices including an input member drivingly coupled to an internal combustion engine, a first rotating electrical machine, a second rotating electrical machine, an output member drivingly coupled to wheels and the second rotating electrical machine, and a differential gear unit.

### DESCRIPTION OF THE RELATED ART

For example, a device described in Japanese Patent Application Publication No. JP-A-2002-316542 is known as a hybrid drive device including an input member drivingly coupled to an internal combustion engine, a first rotating electrical machine, a second rotating electrical machine, an output member drivingly coupled to wheels and the second rotating electrical machine, and a differential gear unit. This hybrid drive device includes a differential gear unit (a planetary gear unit 2) that is formed by three rotating elements, namely a first rotating element (a sun gear 2S), a second rotating element (a carrier 2C), and a third rotating element (a ring gear 2R) in order of the rotational speed. The first rotating electrical machine (an electric generator 3) is drivingly coupled to the first rotating element of the differential gear unit, the input member (an output shaft 1a of an engine 1) is drivingly coupled to the second rotating element, and the output member (an output gear 5a) and the second rotating electrical machine (an electric motor 4) are drivingly coupled to the third rotating element via a rotational direction restricting device (a one-way clutch 11).

The device described in Japanese Patent Application Publication No. JP-A-2002-316542 is structured so that due to the presence of the rotational direction regulating device, rotation is transmitted from the third rotating element of the differential gear unit to the output member, but is not transmitted in the opposite direction. In other words, the rotational direction restricting device is provided so as to allow the output member to rotate only in a positive direction relative to the third rotating element of the differential gear unit. This device includes a rotation restricting device (a brake 10) for selectively fixing the third rotating element of the differential gear unit to a case as a non-rotating member.

In the hybrid drive device of Japanese Patent Application Publication No. JP-A-2002-316542, a series mode is implemented by engaging the brake 10 with the one-way clutch 11 in a disengaged state, and a split mode is implemented by disengaging the brake 10 with the one-way clutch 11 in an engaged state. An electric travel mode using the torque of the electric motor 4 can also be implemented by disengaging the brake 10 with the one-way clutch 11 in the disengaged state. That is, in the device of Japanese Patent Application Publication No. JP-A-2002-316542, these modes can be easily switched by switching the state (the engaged or disengaged state) of the brake 10.

### SUMMARY OF THE INVENTION

In the device of Japanese Patent Application Publication No. JP-A-2002-316542, however, the one-way clutch 11 as the rotational direction restricting device is provided so as to allow the output member to rotate only in the positive direction relative to the third rotating element of the differential gear unit. Thus, in the series mode in which the third rotating element of the differential gear unit is fixed to the case as the non-rotating member by the rotation restricting device (the brake 10), rotation of the output member is restricted so that the output member is allowed to rotate only in the positive direction. That is, the vehicle cannot travel rearward in the series mode that is implemented in the device of Japanese Patent Application Publication No. JP-A-2002-316542. Thus, in the device of Japanese Patent Application Publication No. JP-A-2002-316542, either the split mode or the electric travel mode needs to be selected in order to move the vehicle rearward.

In the split mode, a driving force is transmitted between the input member and the output member via the differential gear unit. Thus, depending on the traveling state of the vehicle such as a low vehicle speed state, and the external environmental conditions such as extremely low temperature conditions, vibrations of the engine which are transmitted to the input member may further be transmitted to the output member, which may reduce the comfort of the occupants. On the other hand, in the electric travel mode, transmission of the driving force between the input member and the output member is cut off. Thus, vibrations of the engine are hardly transmitted to the output member, but it is difficult to ensure a sufficient range with a limited amount of electric power that is stored in an electric power storage device such as a battery. Moreover, depending on the external environmental conditions such as extremely low temperature conditions, it may be difficult to ensure a sufficient amount of torque of the second rotating electrical machine for moving the vehicle rearward.

Accordingly, it is desired to implement hybrid drive devices capable of easily switching modes, and also capable of reducing vibrations and ensuring a sufficient range and a sufficient driving force even when the vehicle travels rearward.

A hybrid drive device according to a first aspect of the present invention includes: an input member drivingly coupled to an internal combustion engine; a first rotating electrical machine; a second rotating electrical machine; an output member drivingly coupled to wheels and the second rotating electrical machine; and a differential gear unit. In the hybrid drive device, the differential gear unit has four rotating elements, which are a first rotating element, a second rotating element, a third rotating element, and a fourth rotating element in order of a rotational speed, the first rotating element of the differential gear unit is drivingly coupled to the first rotating electrical machine, the second rotating element is drivingly coupled to the input member, the third rotating element is selectively fixed to a non-rotating member by a rotating restricting device, the fourth rotating element is selectively drivingly coupled to the output member via a rotational direction restricting device, and the rotational direction restricting device is provided so as to allow the output member to rotate only in a positive direction relative to the fourth rotating element of the differential gear unit.

As used herein, the expression “drivingly coupled” indicates the state in which two rotating elements are coupled together so as to be able to transmit a driving force therebetween, and is used as a concept including the state in which the two rotating elements are coupled together so as to integrally rotate, or the state in which the two rotating elements are coupled together so as to be able to transmit a driving force therebetween via one or more transmission members. Such transmission members include various members that transmit rotation at the same speed or after changing the rotational speed, and for example, include a shaft, a gear mechanism, a belt, a chain, or the like. However, when the expression “drivingly coupled” is used for the rotating elements of the differential gear unit, it indicates the state in which a plurality of rotating elements of the differential gear unit are drivingly coupled together with no other rotating elements interposed therebetween.

The term “rotating electrical machine” is used as a concept that includes a motor (an electric motor), a generator (an electric generator), and a motor-generator that functions both as the motor and the generator as necessary.

The expression “in order of the rotating speed” is either in order from higher to lower speeds or in order from lower to higher speeds, and may be either one depending on the rotating state of each differential gear mechanism, but the order in which the rotating elements are arranged does not change in any case.

The rotational direction of each rotating member is determined based on the rotational direction of the output member in the state in which the vehicle is moving forward. Thus, regarding the rotational direction of each rotating member, the “positive direction” indicates the same direction as the rotational direction of the output member in the state in which the vehicle is moving forward.

According to the first aspect, the series mode can be implemented in the state in which the third rotating element of the differential gear unit is fixed to the non-rotating element by the rotation restricting device, and the fourth rotating element rotates in the positive direction relative to the output member. Moreover, the split mode can be implemented in the state in which the fourth rotating element of the differential gear unit is drivingly coupled to the output member by the rotational direction restricting device so as to integrally rotate with the output member, and the third rotating element is allowed to rotate. The electric travel mode can be implemented in the state in which the output member rotates in the positive direction relative to the fourth rotating element of the differential gear unit, or in the state in which the third rotating element of the differential gear unit is allowed to rotate by the rotation restricting device, and the fourth rotating element of the differential gear unit is drivingly coupled to the output member by the rotation restricting device so as to integrally rotate with the output member. These modes can be easily switched by switching the state of the rotation restricting device.

In the series mode, the second rotating element drivingly coupled to the internal combustion engine and the input member rotates in the positive direction in the state in which the third rotating element of the differential gear unit is fixed to the non-rotating member. Thus, the fourth rotating element, which is located on the side opposite to the second rotating element with respect to the third rotating element in order of the rotational speed, rotates in the negative direction. Accordingly, in the series mode, the output member can rotate in the negative direction at a rotational speed equal to or higher than that of the fourth rotating element. Thus, according to the first aspect, the vehicle can travel rearward in the series mode.

In the series mode, the vehicle can travel by the torque of the second rotating electrical machine in the state in which the first rotating electrical machine is generating electric power. Thus, the vehicle can travel rearward regardless of the amount of charge in an electric power storage device included in the vehicle. Thus, a sufficient range can be ensured when the vehicle moves rearward. Since the second rotating electrical machine outputs torque by consuming electric power generated by the first rotating electrical machine, a sufficient driving force by the torque of the second rotating electrical machine can be ensured regardless of the environment in which the electric power storage device is used, namely even in, e.g., cold environments. Moreover, in the series mode, the vehicle can travel by the torque of the second rotating electrical machine in the state in which torque transmission between the input member and the output member is cut off. Thus, the vehicle can travel rearward while reducing transmission of vibrations of the internal combustion engine, which is drivingly coupled to the input member, to the output member.

Thus, a hybrid drive device can be provided which is capable of easily switching modes, and capable of ensuring a sufficient range and a sufficient driving force while reducing vibrations even when the vehicle travels rearward.

The hybrid drive device may further include a series mode that is implemented in a state in which the third rotating element of the differential gear unit is fixed by the rotation restricting device, and the output member rotates in the positive direction relative to the fourth rotating element of the differential gear unit, wherein in the series mode, torque of the second rotating electrical machine, which is output by consumption of electric power generated by the first rotating electrical machine using torque of the input member, is transmitted to the output member. The hybrid drive device may also further include a series rearward travel mode, as one form of the series mode, in which torque and rotation of the second rotating electrical machine in a negative direction are transmitted to the output member in a state in which the output member rotates at a rotational speed in a range from a rotational speed or higher of the fourth rotating element of the differential gear unit, which is determined based on a rotational speed of the input member, to zero or lower.

According to this structure, in the series mode, the vehicle can travel by the torque of the second rotating electrical machine regardless of the amount of charge in the electric power storage device included in the vehicle, by using the electric power generated by the first rotating electrical machine. Moreover, the vehicle can travel while reducing transmission of vibrations of the internal combustion engine, which is drivingly coupled to the input member, to the output member in the state in which torque transmission between the input member and the output member is cut off.

In the series rearward travel mode as the one form of the series mode, the vehicle can be reliably moved rearward at a vehicle speed in the range from the rotational speed or higher of the fourth rotating element of the differential gear unit, which is determined based on the rotational speed of the input member, to zero or lower. Since the hybrid drive device has such a series rearward travel mode, the hybrid drive device can be appropriately implemented which is capable of ensuring a sufficient range and a sufficient driving force while reducing vibrations even when the vehicle moves rearward.

The hybrid drive device may further include a split mode that is implemented in a state in which the fourth rotating element of the differential gear unit is drivingly coupled to the output member by the rotational direction restricting device so as to integrally rotate with the output member, and the third rotating element of the differential gear unit is allowed to rotate by the rotation restricting device, wherein in the split mode, torque of the input member is transmitted to the output member while the torque is distributed to the first rotating electrical machine.

According to this structure, in the split mode, the vehicle can travel by transmitting to the output member both the torque of the input member (the internal combustion engine) that is transmitted to the output member via the differential gear unit, and the torque of the second rotating electrical machine. Thus, the vehicle can travel appropriately even when a large driving force is required. Moreover, the vehicle can travel by continuously changing the rotational speed of the input member by the differential gear unit, and transmitting the resultant rotational speed to the output member. At this time, by using the internal combustion engine and the second rotating electrical machine that is driven by the electric power generated by the first rotating electrical machine, the vehicle can travel regardless of the amount of charge in the electric power storage device included in the vehicle.

The hybrid drive device may further include a first electric forward travel mode that is implemented in a state in which the output member rotates in the positive direction relative to the fourth rotating element of the differential gear unit, wherein in the first electric forward travel mode, only the second rotating electrical machine outputs torque among the internal combustion engine, the first rotating electrical machine, and the second rotating electrical machine, and the torque and rotation of the second rotating electrical machine in the positive direction are transmitted to the output member.

According to this structure, in the first electric forward travel mode, the vehicle can appropriately travel forward by the torque of the second rotating electrical machine. It is generally relatively easy to precisely control the torque and the rotational speed of rotating electrical machines. Thus, the vehicle can appropriately travel forward according to the required driving force. In the case where a large amount of charge remains in the electric power storage device in the vehicle, the vehicle can travel forward by the torque of the second rotating electrical machine while reducing transmission of vibrations to the output member.

The hybrid drive device may further include a first electric rearward travel mode that is implemented in a state in which the third rotating element of the differential gear unit is allowed to rotate by the rotation restricting device, and the fourth rotating element of the differential gear unit is drivingly coupled to the output member by the rotation restricting device so as to integrally rotate with the output member, wherein in the first electric rearward travel mode, only the second rotating electrical machine outputs torque among the internal combustion engine, the first rotating electrical machine, and the second rotating electrical machine, and the torque and rotation of the second rotating electrical machine in the negative direction are transmitted to the output member.

According to this structure, in the first electric forward travel mode, the vehicle can appropriately travel rearward by the torque of the second rotating electrical machine. It is generally relatively easy to precisely control the torque and the rotational speed of rotating electrical machines. Thus, the vehicle can appropriately travel rearward according to the required driving force. In the case where a large amount of charge remains in the electric power storage device in the vehicle, the vehicle can travel rearward by the torque of the second rotating electrical machine while reducing transmission of vibrations to the output member.

The hybrid drive device may further include a second rotational direction restricting device that is provided between the non-rotating member and the input member, and restricts rotation of the input member so that the input member is allowed to rotate only in the positive direction relative to the non-rotating member, with the rotational direction restricting device serving as a first rotational direction restricting device. The hybrid drive device may also further include a second electric travel mode that is implemented in a state in which the third rotating element of the differential gear unit is allowed to rotate by the rotation restricting device, the fourth rotating element of the differential gear unit is drivingly coupled to the output member by the first rotational direction restricting device so as to integrally rotate with the output member, and the input member is fixed to the non-rotating member by the second rotational direction restricting device, wherein in the second electric travel mode, torque and rotation of the first rotating electrical machine are reversed in direction and transmitted to the output member, and torque and rotation of the second rotating electrical machine are transmitted to the output member.

According to this structure, in the second electric travel mode, the vehicle can appropriately travel by both the torque of the first rotating electrical machine and the torque of the second rotating electrical machine. Thus, even when a large driving force is required, the vehicle can appropriately travel while maintaining the internal combustion engine that is drivingly coupled to the input member in a stopped state. It is generally relatively easy to precisely control the torque and the rotational speed of rotating electrical machines. Thus, the vehicle can appropriately travel according to the required driving force.

The hybrid drive device may further include a second rotation direction restricting device that is provided between the non-rotating member and the input member, and restricts rotation of the input member so that the input member is allowed to rotate only in the positive direction relative to the non-rotating member, with the rotational direction restricting device serving as a first rotational direction restricting device.

According to this structure, the second electric travel mode can be implemented as a state in which the third rotating element of the differential gear unit is allowed to rotate by the rotation restricting device, while the fourth rotating element of the differential gear unit is drivingly coupled to the output member by the first rotational direction restricting device so as to integrally rotate with the output member, and the input member is fixed to the non-rotating member by the second rotational direction restricting member.

The rotation restricting device may be a two-way clutch that is provided between the non-rotating member and the third rotating element of the differential gear unit, and includes, as switchable states, at least three states from: a state in which the third rotating element of the differential gear unit is allowed to rotate in both of the directions relative to the non-rotating member; a state in which the rotation of the third rotating element of the differential gear unit is restricted so that the third rotating element is allowed to rotate only in the positive direction relative to the non-rotating member; a state in which the rotation of the third rotating element of the differential gear unit is restricted so that the third rotating element is allowed to rotate only in the negative direction relative to the non-rotating member; and a state in which the rotation of the third rotating element of the differential gear unit is restricted so that the third rotating element is restricted from rotating in both of directions relative to the non-rotating member so as to stop the rotation of the third rotating element.

The third rotating element of the differential gear unit can be reliably fixed by bringing the two-way clutch into the state in which the third rotating element of the differential gear unit is restricted from rotating in both of directions relative to the non-rotating member so as to stop the rotation of the third rotating element. If the third rotating element of the differential gear unit attempts to rotate in the positive direction, the third rotating element of the differential gear unit can also be fixed by bringing the two-way clutch into the state in which the third rotating element is allowed to rotate only in the negative direction. If the third rotating element of the differential gear unit attempts to rotate in the negative direction, the third rotating element of the differential gear unit can also be fixed by bringing the two-way clutch into the state in which the third rotating element is allowed to rotate only in the positive direction. On the contrary, if the third rotating element of the differential gear unit attempts to rotate in the positive direction, the rotation of the third rotating element of the differential gear unit can also be allowed by bringing the two-way clutch into the state in which the third rotating element is allowed to rotate only in the positive direction. If the third rotating element of the differential gear unit attempts to rotate in the negative direction, the rotation of the third rotating element of the differential gear unit can also be allowed by bringing the two-way clutch into the state in which the third rotating element is allowed to rotate only in the negative direction.

According to this structure, in each mode that can be implemented by the hybrid drive device, the state in which the rotation of the third rotating element of the differential gear unit is allowed by the two-way clutch can be appropriately implemented by bringing the two-way clutch into the state in which the third rotating element of the differential gear unit is allowed to rotate in both of the directions, or the state in which the third rotating element of the differential gear unit is allowed to rotate only in the positive or negative direction, according to the relation with a possible rotational speed of the third rotating element of the differential gear unit. Moreover, the state in which the third rotating element of the differential gear unit is fixed by the two-way clutch can be appropriately implemented by bringing the two-way clutch into the state in which the third rotating element of the differential gear unit is restricted from rotating in both of directions so as to stop rotation of the third rotating element, or the state in which the third rotating element of the differential gear unit is allowed to rotate only in the positive or negative direction, according to the relation with a possible rotational speed of the third rotating element of the differential gear unit. Thus, each mode of the hybrid drive device can be easily and appropriately implemented by switching the two-way clutch among at least three of the four states as appropriate.

Note that according to this structure, the hybrid drive device of the present invention can be structured without using, e.g., a friction engagement brake that is operated by a fluid pressure or an electromagnetic force. This eliminates the need to continuously generate the fluid pressure of the electromagnetic force to maintain each possible state of the two-way clutch, unlike, e.g., the friction engagement brake or the like. That is, this allows the structure to be used in which the fluid pressure or the electromagnetic force is generated only when switching the two-way clutch among its possible states. Thus, the overall energy efficiency of the hybrid drive device can be increased.

Alternatively, the rotation restricting device may be a friction engagement brake that is provided between the non-rotating member and the third rotating element of the differential gear unit, and includes two switchable states, which are a state in which the third rotating element of the differential gear unit is allowed to rotate in both of the directions relative to the non-rotating member, and a state in which the third rotating element of the differential gear unit is restricted from rotating in both of the directions relative to the non-rotating member so as to be fixed.

According to this structure, the manufacturing cost of the hybrid drive device can be reduced by using a general-purpose part such as the friction engagement brake that is operated by a fluid pressure or an electromagnetic force.

### BRIEF DESCRIPTION OF THE DRAWINGS

FIG. 1 is a skeleton diagram of a hybrid drive device according to a first embodiment;

FIG. 2 is a schematic diagram showing a system configuration of the hybrid drive device according to the first embodiment;

FIG. 3 is an operation table showing the states in each mode according to the first embodiment;

FIG. 4 is a velocity diagram in a series mode according to the first embodiment;

FIG. 5 is a velocity diagram in a split mode according to the first embodiment;

FIG. 6 is a velocity diagram in an electric forward travel mode according to the first embodiment;

FIG. 7 is a velocity diagram in an electric rearward travel mode according to the first embodiment;

FIG. 8 is a velocity diagram in an internal combustion engine start mode according to the first embodiment;

FIG. 9 is a velocity diagram illustrating a process of switching between the series mode and the split mode according to the first embodiment;

FIGS. 10A and 10B are timing charts each illustrating a process of switching the mode in order of the split mode, an electric travel mode, and the split mode according to the first embodiment;

FIG. 11 is a schematic cross-sectional view specifically showing a specific structure of a two-way clutch according to the first embodiment;

FIG. 12 is a skeleton diagram of a hybrid drive device according to a second embodiment;

FIG. 13 is an operation table showing the states in each mode according to the second embodiment;

FIG. 14 is a velocity diagram in a second electric travel mode according to the second embodiment; and

FIG. 15 is a skeleton diagram of a hybrid drive device according to other embodiment.

### DETAILED DESCRIPTION OF THE EMBODIMENTS

### 1. First Embodiment

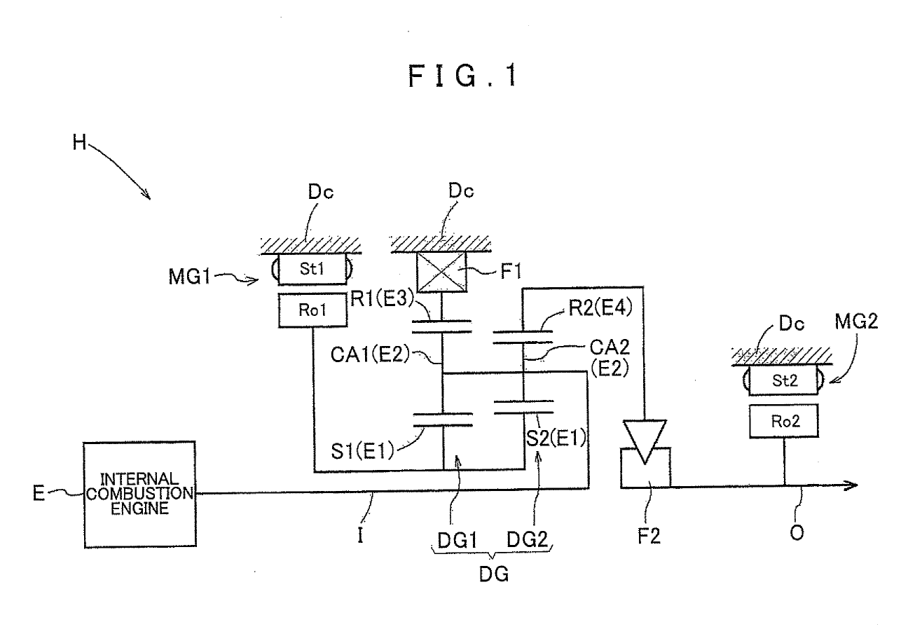

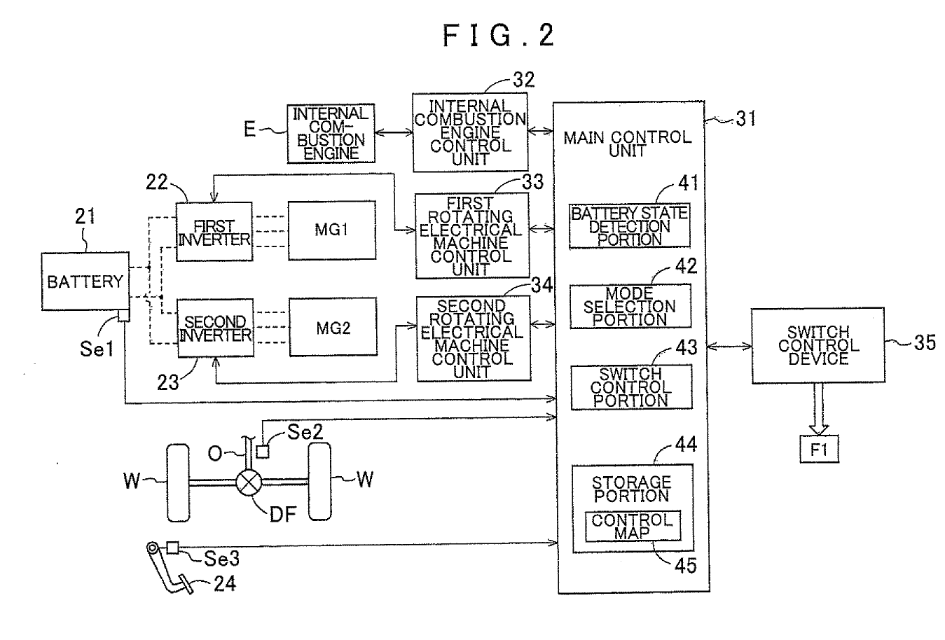

A first embodiment of the present invention will be described below with reference to the accompanying drawings. FIG. 1 is a skeleton diagram showing a mechanical structure of a hybrid drive device H according to the present embodiment. Note that the lower half structure that is symmetrical with respect to the central axis is not shown in FIG. 1. FIG. 2 is a schematic diagram showing a system configuration of the hybrid drive device H according to the present embodiment. Note that in FIG. 2, solid arrows represent transmission paths of various information, broken lines represent transmission paths of electric power, and an outline arrow represents a transmission path of motive power.

As shown in FIG. 1, the hybrid drive device H includes: an input shaft I drivingly coupled to an internal combustion engine E; a first rotating electrical machine MG1; a second rotating electrical machine MG2; an output shaft O drivingly coupled to wheels W (see FIG. 2) and the second rotating electrical machine MG2; and a differential gear unit DG formed by a first differential gear unit DG1 and a second differential gear unit DG2, and having a total of four rotating elements. These structures are accommodated in a drive device case Dc (hereinafter simply referred to as the “case Dc”) as a non-rotating member fixed to a vehicle body. Note that in the present embodiment, the input shaft I corresponds to an “input member” in the present invention, and the output shaft O corresponds to an “output member” in the present invention.

In this structure, the hybrid drive device H of the present embodiment is characterized by including a two-way clutch F1 and a one-way clutch F2, which are provided to regulate as appropriate the relations in which the input shaft I, the output shaft O, and the first rotating electrical machine MG1 are drivingly coupled to the rotating elements of the differential gear unit DG, and to regulate as appropriate rotation and the rotational direction of predetermined ones of the rotating elements of the differential gear unit DG. Thus, the hybrid drive device H is implemented which is capable of easily switching modes, and also capable of reducing vibrations and ensuring a sufficient range and a sufficient driving force even when the vehicle travels rearward. The hybrid drive device H of the present embodiment will be described in detail below.

1-1. Structure of Each Part of Hybrid Drive Device As shown in FIG. 1, the input shaft I is drivingly coupled to the internal combustion engine E. The internal combustion engine E is a device that is driven by combustion of fuel in the engine to output motive power, and various known engines, such as a gasoline engine, a diesel engine, and a gas turbine engine, can be used as the internal combustion engine E. In this example, the input shaft I is drivingly coupled to an output rotation shaft such as a crankshaft of the internal combustion engine E so as to integrally rotate with the output rotation shaft. Note that it is also preferable that the input shaft I be drivingly coupled to the output rotation shaft of the internal combustion engine E via a damper, a clutch, or the like. The input shaft I is drivingly coupled to a first carrier CA1 of the first differential gear unit DG1 and a second carrier CA2 of the second differential gear unit DG2 so as to integrally rotate with the first carrier CA1 and the second carrier CA2. The output shaft O is drivingly coupled to a rotor Ro2 of the second rotating electrical machine MG2 so as to integrally rotate with the rotor Ro2, and is selectively drivingly coupled to a second ring gear R2 of the second differential gear unit DG2 via the one-way clutch F2. As shown in FIG. 2, the output shaft O is drivingly coupled to the wheels W via an output differential gear unit DF or the like so as to be able to transmit a driving force to the wheels W. In this example, the output shaft O is positioned coaxially with the input shaft I.

As shown in FIG. 1, the first rotating electrical machine MG1 has a stator St1 fixed to the case Dc, and a rotor Ro1 rotatably supported radially inside the stator St1 The rotor Ro1 of the first rotating electrical machine MG1 is drivingly coupled to a first sun gear S1 of the first differential gear unit DG1 and a second sun gear S2 of the second differential gear unit DG2 so as to integrally rotate therewith. The second rotating electrical machine MG2 has a stator St2 fixed to the case Dc, and the rotor Ro2 rotatably supported radially inside the stator St2. The rotor Ro2 of the second rotating electrical machine MG2 is drivingly coupled to the output shaft O so as to integrally rotate therewith, and is selectively drivingly coupled to the second ring gear R2 of the second differential gear unit DG2 via the one-way clutch F2. Both the first rotating electrical machine MG1 and the second rotating electrical machine MG2 are positioned coaxially with the input shaft I and the output shaft O. This structure is suitable as a structure of the hybrid drive device H that is mounted on, e.g., front engine rear drive (FR) vehicles. As shown in FIG. 2, the first rotating electrical machine MG1 and the second rotating electrical machine MG2 are electrically connected to a battery 21 as an electric power storage device via a first inverter 22 and a second inverter 23. Note that the battery 21 is an example of the electric power storage device, and other electric power storage device such as a capacitor, or a plurality of kinds of electric power storage devices may be used.

The first rotating electrical machine MG1 and the second rotating electrical machine MG2 are capable of functioning both as a motor (an electric motor) that is supplied with electric power to generate motive power, and a generator (an electric generator) that is supplied with motive power to generate electric power. When functioning as a generator, the first rotating electrical machine MG1 and the second rotating electrical machine MG2 generate electric power by the driving force of the internal combustion engine E and the inertial force of the vehicle, and charge the battery 21 or supply the electric power for driving the other rotating electrical machine MG1, MG2 functioning as a motor. On the other hand, when functioning as a motor, the first rotating electrical machine MG1 and the second rotating electrical machine MG2 are charged by the battery 21, or is powered by receiving supply of the electric power generated by the other rotating electrical machine MG1, MG2 functioning as a generator. The operational control of the first rotating electrical machine MG1 is performed via a first rotating electrical machine control unit 33 and the first inverter 22 according to a control command from a main control unit 31, and the operational control of the second rotating electrical machine MG2 is performed via a second rotating electrical machine control unit 34 and the second inverter 23 according to a control command from the main control unit 31.

The first differential gear unit DG1 is formed by a single-pinion type planetary gear mechanism positioned coaxially with the input shaft I. That is, the first differential gear unit DG1 has, as rotating elements, the first carrier CA1 that supports a plurality of pinion gears, and the first sun gear S1 and a first ring gear R1 that mesh with the pinion gears. The first sun gear S1 is drivingly coupled to the rotor Ro1 of the first rotating electrical machine MG1 and the second sun gear S2 of the second differential gear unit DG2 so as to integrally rotate therewith. The first carrier CA1 is drivingly coupled to the input shaft I and the second carrier CA2 of the second differential gear unit DG2 so as to integrally rotate therewith. The first ring gear R1 is selectively fixed to the case Dc by the two-way clutch F1. As shown in the velocity diagrams of FIGS. 4 to 9, these three rotating elements of the first differential gear unit DG1 are the first sun gear S1, the first carrier CA1, and the first ring gear R1 in order of the rotational speed.

The second differential gear unit DG2 is formed by a single-pinion type planetary gear mechanism positioned coaxially with the input shaft I. That is, the second differential gear unit DG2 has, as rotating elements, the second carrier CA2 that supports a plurality of pinion gears, and the second sun gear S2 and the second ring gear R2 that mesh with the pinion gears. The second sun gear S2 is drivingly coupled to the rotor Ro1 of the first rotating electrical machine MG1 and the first sun gear S1 of the first differential gear unit DG1 so as to integrally rotate therewith. The second carrier CA2 is drivingly coupled to the input shaft I and the first carrier CA1 of the first differential gear unit DG1 so as to integrally rotate therewith. The second ring gear R2 is selectively drivingly coupled to the output shaft O and the rotor Ro2 of the second rotating electrical machine MG2 via the one-way clutch F2. As shown in the velocity diagrams of FIGS. 4 to 9, these three rotating elements of the second differential gear unit DG2 are the second sun gear S2, the second carrier CA2, and the second ring gear R2 in order of the rotational speed.

In the present embodiment, the “differential gear unit DG” in the present invention is formed by the first differential gear unit DG1 and the second differential gear unit DG2. That is, in the present embodiment, the first sun gear S1 of the first differential gear unit DG1 and the second sun gear S2 of the second differential gear unit DG2 are drivingly connected together so as to rotate together. Moreover, the first carrier CA1 of the first differential gear unit DG1 and the second carrier CA2 of the second differential gear unit DG2 are drivingly connected together so as to integrally rotate. Thus, the two rotating elements of the first differential gear unit DG1 are respectively coupled with the two rotating elements of the second differential gear unit DG2, whereby the first differential gear unit DG1 and the second differential gear unit DG2 form the four-element differential gear unit DG. In the present embodiment, the gear ratio λ2 of the planetary gear mechanism of the second differential gear unit DG2 is set to a value larger than the gear ratio λ1 of the planetary gear mechanism of the first differential gear unit DG1 (λ2>λ1, see FIGS. 4 to 9). Note that the gear ratio of each planetary gear mechanism is the ratio of the number of teeth of the sun gear to the number of teeth of the ring gear of the planetary gear mechanism (=[the number of teeth of the sun gear]/[the number of teeth of the ring gear]).

Thus, in the present embodiment, the four rotating elements of the differential gear unit DG that is formed by the first differential gear unit DG1 and the second differential gear unit DG2 are the first sun gear S1 and the second sun gear S2 that rotate together (hereinafter referred to as the “integral sun gear S”), the first carrier CA1 and the second carrier CA2 that rotate together (hereinafter referred to as the “integral carrier CA”), the first ring gear R1, and the second ring gear R2 in order of the rotational speed. Accordingly, in the present embodiment, the integral sun gear S, the integral carrier CA, the first ring gear R1, and the second ring gear R2 correspond to a “first rotating element E1,” a “second rotating element E2,” a “third rotating element E3,” and a “fourth rotating element E4” of the differential gear unit DC, respectively.

The two-way clutch F1 is provided between the case Dc as the non-rotating member and the first ring gear R1 so as to selectively fix the first ring gear R1 of the first differential gear unit DG1 (the third rotating element E3 of the differential gear unit DG) to the case De to stop rotation of the first ring gear R1. In the present embodiment, the two-way clutch F1 includes four switchable states, which are a disengaged state, a one-way engaged state, the other-way engaged state, and a two-way engaged state. As used herein, the “disengaged state” indicates the state in which the first ring gear R1 is allowed to rotate in both directions (positive and negative directions) relative to the case Dc. In the present embodiment, the “one-way engaged state” indicates the state in which rotation of the first ring gear R1 relative to the case Dc is restricted so that the first ring gear R1 is allowed to rotate only in the positive direction relative to the case Dc. That is, in the one-way engaged state, the two-way clutch F1 allows the first ring gear R1 to rotate in the positive direction relative to the case Dc, but does not allow the first ring gear R1 to rotate in the negative direction relative to the case Dc. For example, if the rotational speed of the first ring gear R1 is continuously changed in the negative direction while the first ring gear R1 is rotating in the positive direction, the two-way clutch F1 is engaged when the rotational speed of the first ring gear R1 becomes zero, whereby the first ring gear R1 is fixed to the case Dc.

In the present embodiment, the “other-way engaged state” indicates the state in which rotation of the first ring gear R1 relative to the case Dc is restricted so that the first ring gear R1 is allowed to rotate only in the negative direction relative to the case Dc. That is, in the other-way engaged state, the two-way clutch F1 does not allow the first ring gear R1 to rotate in the positive direction relative to the case Dc, but allows the first ring gear R1 to rotate in the negative direction relative to the case De. For example, if the rotational speed of the first ring gear R1 is continuously changed in the positive direction while the first ring gear R1 is rotating in the negative direction, the two-way clutch F1 is engaged when the rotational speed of the first ring gear R1 becomes zero, whereby the first ring gear R1 is fixed to the case Dc. The “two-way engaged state” indicates the state in which the first ring gear R1 is restricted from rotating in both directions (in both of the positive and negative directions) relative to the case Dc so as to stop rotation of the first ring gear R1. Thus, the two-way clutch F1 of the present embodiment functions as a brake. In the present embodiment, the two-way clutch F1 corresponds to a “rotation restricting device” in the present invention.

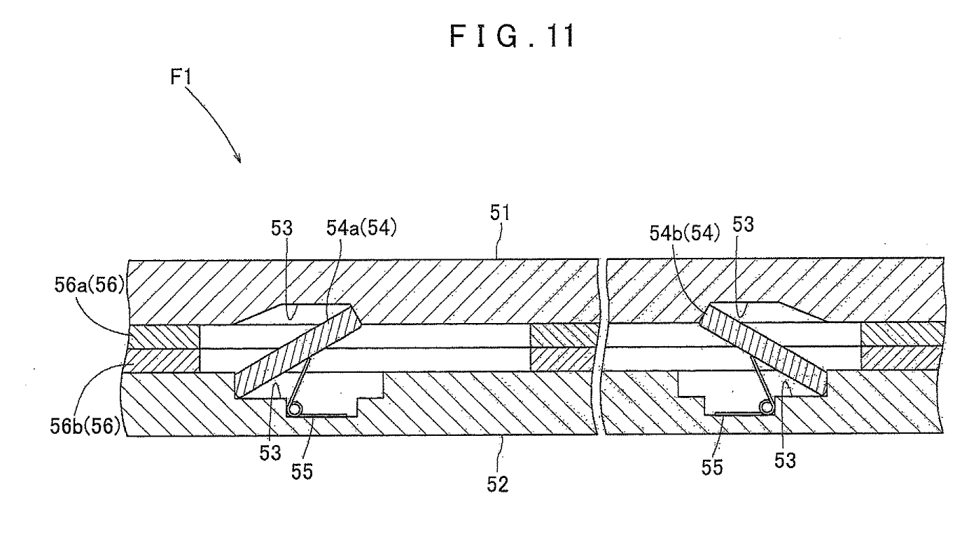

FIG. 11 is a schematic circumferential cross section showing a specific structure of the two-way clutch F1 of the present embodiment. As shown in the figure, the two-way clutch F1 of the present embodiment includes a substantially disc-shaped first rotating member 51, a substantially disc-shaped second rotating member 52, a plurality of latch members 54, and a substantially disc-shaped inhibiting member 56. The first rotating member 51 and the second rotating member 52 are coaxially positioned, and face each other so as to be rotatable relative to each other. The plurality of latch members 54 are disposed so as to be able to be latched in both the first rotating member 51 and the second rotating member 52 while being biased by elastic members 55 such as springs. The inhibiting member 56 is capable of rotating relative to the first rotating member 51 and the second rotating member 52 to inhibit the latch members 54 from being latched in both the first rotating member 51 and the second rotating member 52 against the biasing force of the elastic members 55. The first rotating member 51 and the second rotating member 52 have recesses 53, and face each other so that the recesses 53 of the first rotating member 51 face the recesses 53 of the second rotating member 52. The latch members 54 and the elastic members 55 are housed in the recesses 53. The latch members 54 are latched in both the first rotating member 51 and the second rotating member 52 in the recesses 53 while being biased from the second rotating member 52 side toward the first rotating member 51 by the elastic members 55. In this state, relative rotation between the first rotating member 51 and the second rotating member 52 is restricted in the direction in which the latch members 54 are tension-supported in the recesses 53. The two-way clutch F1 of the present embodiment includes, as the latch members 54, a first latch member 54a and a second latch member 54b which are tension-supported in the recesses 53 in opposite directions to each other. The two-way clutch F1 includes a first inhibiting member 56a capable of inhibiting the first latch member 54a from being latched in both the first rotating member 51 and the second rotating member 52, and a second inhibiting member 56b capable of inhibiting the second latch member 54b from being latched in both the first rotating member 51 and the second rotating member 52.

In the state in which both the first latch member 54a and the second latch member 54b are latched by both the first rotating member 51 and the second rotating member 52, relative rotation between the first rotating member 51 and the second rotating member 52 is restricted in both directions, thereby stopping rotations of the first rotating member 51 and the second rotating member 52. This state is the “two-way engaged state” described above. In FIG. 11, in the state in which the first inhibiting member 56a slides rightward (rotates clockwise) to inhibit the first latch member 54a from being latched by both the first rotating member 51 and the second rotating member 52, relative rotation between the first rotating member 51 and the second rotating member 52 is allowed only in one direction by the second latch member 54b (in the example of FIG. 11, the first rotating member 51 is allowed to rotate only leftward (counterclockwise) relative to the second rotating member 52). In FIG. 11, in the state in which the second inhibiting member 56b slides leftward (rotates counterclockwise) to inhibit the second latch member 54b from being latched by both the first rotating member 51 and the second rotating member 52, relative rotation between the first rotating member 51 and the second rotating member 52 is allowed only in the other direction by the first latch member 54a (in the example of FIG. 11, the first rotating member 51 is allowed to rotate only rightward (clockwise) relative to the second rotating member 52). One of these states is the “one-way engaged state” described above, and the other state is the “other-way engaged state” described above. In FIG. 11, in the state in which the first inhibiting member 56a slides rightward (rotates clockwise) and the second inhibiting member 56b slides leftward (rotates counterclockwise) to inhibit both the first latch member 54a and the second latch member 54b from being latched by both the first rotating member 51 and the second rotating member 52, relative rotation between the first rotating member 51 and the second rotating member 52 is allowed in both directions. This state is the “disengaged state” described above.

In the present embodiment, a switch control device 35 (see FIG. 2) is provided so as to switch the state of the two-way clutch F1, in other words, to switch the latch inhibition state of the first latch member 54a and the second latch member 54b using the first inhibiting member 56a and the second inhibiting member 56b by rotating the first inhibiting member 56a and the second inhibiting member 56b relative to the first rotating member 51 and the second rotating member 52. In the present embodiment, an electric actuator such as a linear motor is used as the switch control device 35. Note that a hydraulic actuator using a hydraulic pressure generated by an electric oil pump or the like may be used to form the switch control device 35. In such a structure of the two-way clutch F1, the switch control device 35 need be operated only when switching the two-way clutch F1 among its possible states. This eliminates the need to continuously generate an electromagnetic force to maintain the engaged state or the disengaged state, unlike the case of using, e.g., a friction engagement brake or the like. Thus, the overall energy efficiency of the hybrid drive device H can be increased by using such a two-way clutch F1 as the rotation restricting device.

Note that it is also possible to employ a structure in which a friction engagement brake having two switchable states, namely a disengaged state and an engaged state, is used as the rotation restricting device. The disengaged state of the brake indicates the state in which the first ring gear R1 is allowed to rotate in both directions (the positive and negative directions) relative to the case Dc. The engaged state of the brake indicates the state in which the first ring gear R1 is restricted from rotating in both directions relative to the case Dc so as to fix the first ring gear R1. A friction engagement device (a friction engagement brake) such as a hydraulically operated multi-disc brake can be used as such a brake. Note that in this case, it is preferable that the structure include a hydraulic control device for controlling the hydraulic pressure that is supplied to the friction engagement brake. The friction engagement brake may be structured to be operated by an electromagnetic force instead of the hydraulic pressure. Such a friction engagement brake is a general-purpose part that is widely used in common vehicle drive devices. Thus, the use of the friction engagement brake as the rotation restricting device is advantageous in that the manufacturing cost of the hybrid drive device H can be reduced.

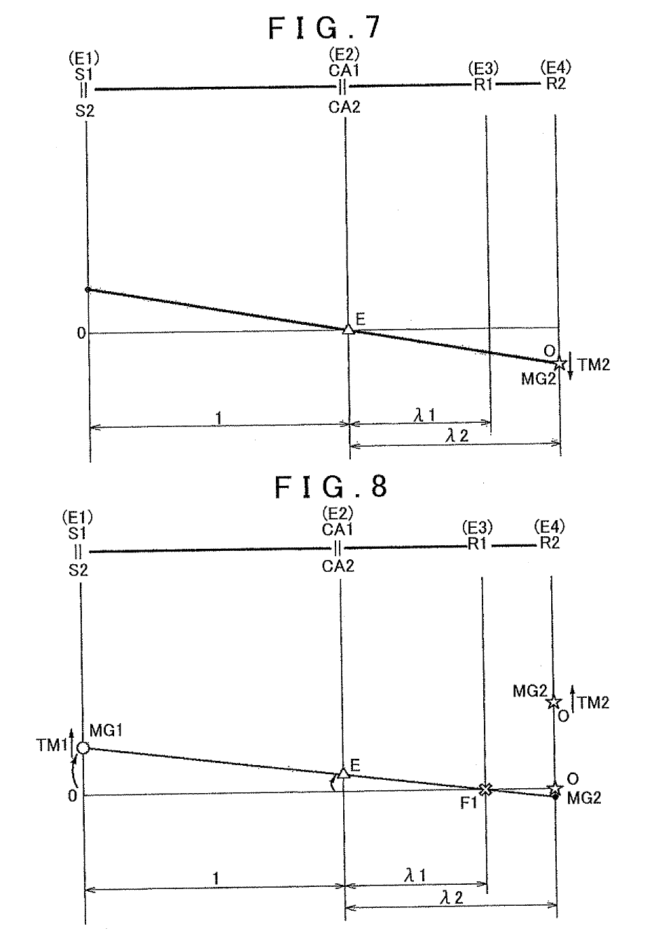

The one-way clutch F2 is provided between the second ring gear R2 and the output shaft O so as to allow the output shaft O to rotate only in the positive direction relative to the second ring gear R2 of the second differential gear unit DG2 (the fourth rotating element E4 of the differential gear unit DC). That is, the one-way clutch F2 is provided so as to allow the output shaft O to rotate in the positive direction relative to the second ring gear R2, and so as not to allow the output shaft O from rotating in the negative direction relative to the second ring gear R2. For example, as shown in FIG. 7, if the second rotating electrical machine MG2 continuously outputs torque TM2 in the negative direction, the output shaft O attempts to rotate in the negative direction relative to the second ring gear R2, and the one-way clutch F2 is engaged, whereby the second ring gear R2 and the output shaft O are drivingly coupled together so as to rotate together. In the present embodiment, the one-way clutch F2 corresponds to a “rotational direction restricting device” in the present invention.

1-2. Structure of Control System of Hybrid Drive Device

As shown in FIG. 2, the hybrid drive device H includes a main control unit 31 for controlling each part of the device. The main control unit 31 is connected with an internal combustion engine control unit 32, the first rotating electrical machine control unit 33, the second rotating electrical machine control unit 34, and the switch control device 35 so that information can be transmitted to each other. The internal combustion engine control unit 32 controls each part of the internal combustion engine E to control the internal combustion engine E to output a desired rotational speed and torque. The first rotating electrical machine control unit 33 controls the first inverter 22 to control the first rotating electrical machine MG1 to output a desired rotational speed and torque. The second rotating electrical machine control unit 34 controls the second inverter 23 to control the second rotating electrical machine MG2 to output a desired rotational speed and torque.

The main control unit 31 is structured so as to be able to obtain information from sensors provided in each part of the vehicle, in order to obtain information of each part of the vehicle to which the hybrid drive device H is mounted. In the illustrated example, the main control unit 31 is structured so as to be able to obtain information from a battery state detection sensor Se1, a vehicle speed sensor Se2, and an accelerator operation detection sensor Se3. The battery state detection sensor Se1 is a sensor for detecting the state of the battery 21 such as the amount of charge, and is formed by, e.g., a voltage sensor, a current sensor, or the like. The vehicle speed sensor Se2 is a sensor for detecting the rotational speed of the output shaft O in order to detect the vehicle speed. The accelerator operation detection sensor Se3 is a sensor for detecting the operation amount of an accelerator pedal 24.

The main control unit 31 selects an operation mode from a plurality of operation modes described below, by using information obtained by the sensors Se1 to Se3. The main control unit 31 switches the state of the two-way clutch F1 via the switch control device 35, and controls the rotational speed and the torque of the first rotating electrical machine MG1 and the second rotating electrical machine MG2 to switch the operation mode. The main control unit 31 cooperatively controls the operation state of the internal combustion engine E, the first rotating electrical machine MG1, and the second rotating electrical machine MG2 via the internal combustion engine control unit 32, the first rotating electrical machine control unit 33, and the second rotating electrical machine control unit 34 so that the vehicle travels appropriately according to the selected operation mode.

In the present embodiment, the main control unit 31 includes a battery state detection portion 41, a mode selection portion 42, and a switch control portion 43 as function portions for performing various control. Each function portion (each unit) included in the main control unit 31 is structured so that the function portions for performing various processes on input data are mounted by either hardware or software (a program) or both by using an arithmetic processing unit such as a CPU as a core member. The main control unit 31 includes a storage portion 44, and a control map 45, which is used to determine the operation mode according to the vehicle speed and a required driving force, is stored in the storage portion 44.

The battery state detection portion 41 estimates and detects the battery state such as the amount of change in the battery 21, based on information such as a voltage value and a current value that are output from the battery state detection sensor Se1. The amount of charge in the battery is generally referred to as the “state of charge (SOC),” and is obtained as, e.g., a ratio of the remaining amount of charge to the charge capacity of the battery 21.

The mode selection portion 42 selects an appropriate operation mode by using a predetermined control map, according to the state of each part of the vehicle. In the present embodiment, the mode selection portion 42 selects an appropriate operation mode from four operation modes described below, according to traveling conditions such as the vehicle speed, the required driving force, and the amount of charge in the battery. The operation modes will be described in detail below. The required driving force is a value representing a driving force that is required for the vehicle by the driver, and is arithmetically obtained by the mode selection portion 42 based on the output of the accelerator operation detection sensor Se3. The vehicle speed is detected by the vehicle speed sensor Se2. The amount of charge in the battery is detected by the battery state detection portion 41. Note that it is also preferable to use various conditions such as the cooling water temperature and the oil temperature, as the traveling conditions that are referred to when selecting the mode, in addition to the vehicle speed, the required driving force, and the amount of charge in the battery.

The switch control portion 43 controls operation of the switch control device 35 according to the operation mode selected by the mode selection portion 42 to switch the two-way clutch F1 among the disengaged state, the one-way engaged state, the other-way engaged state, and the two-way engaged state. Thus, the switch control portion 43 performs part of the control for switching the operation mode of the hybrid control device H.

1-3. Plurality of Switchable Modes

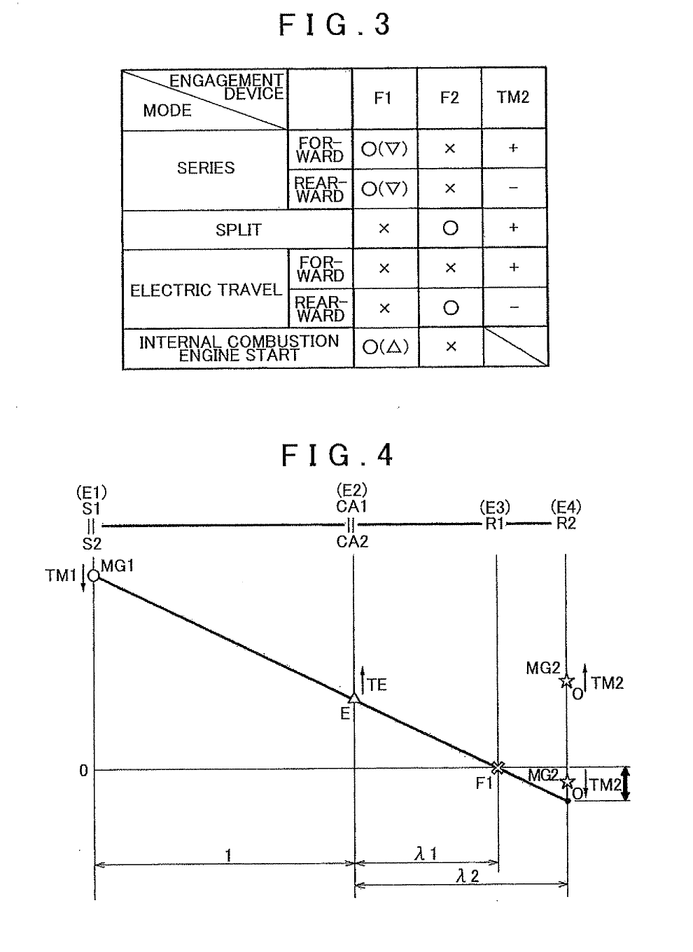

The modes that can be implemented by the hybrid drive device H of the present embodiment will be described below. FIG. 3 is an operation table showing the operating states of the engagement devices F1, F2 in each mode. This table also shows the direction of the torque TM2 of the second rotating electrical machine MG2 during normal traveling in each mode. In FIG. 3, “◯” indicates that each engagement device is in the engaged state (the two-way clutch F1 is in the two-way engaged state), and “X” indicates that each engagement device is in the disengaged state. Note that “(Δ)” indicates that the two-way clutch F1 may be in the one-way engaged state instead of the two-way engaged state, and “(∇)” indicates that the two-way clutch F1 may be in the other-way engaged state instead of the two-way engaged state. In FIG. 3, “+” indicates that the torque TM2 of the second rotating electrical machine MG2 is in the positive direction, and “−” indicates that the torque TM2 of the second rotating electrical machine MG2 is in the negative direction. As shown in FIG. 3, in the present embodiment, the hybrid drive device H includes three switchable modes, a “series mode,” a “split mode,” and an “electric travel mode,” as normal travel modes, and additionally includes an “internal combustion engine start mode.” Thus, the hybrid drive device H includes a total of four switchable modes.

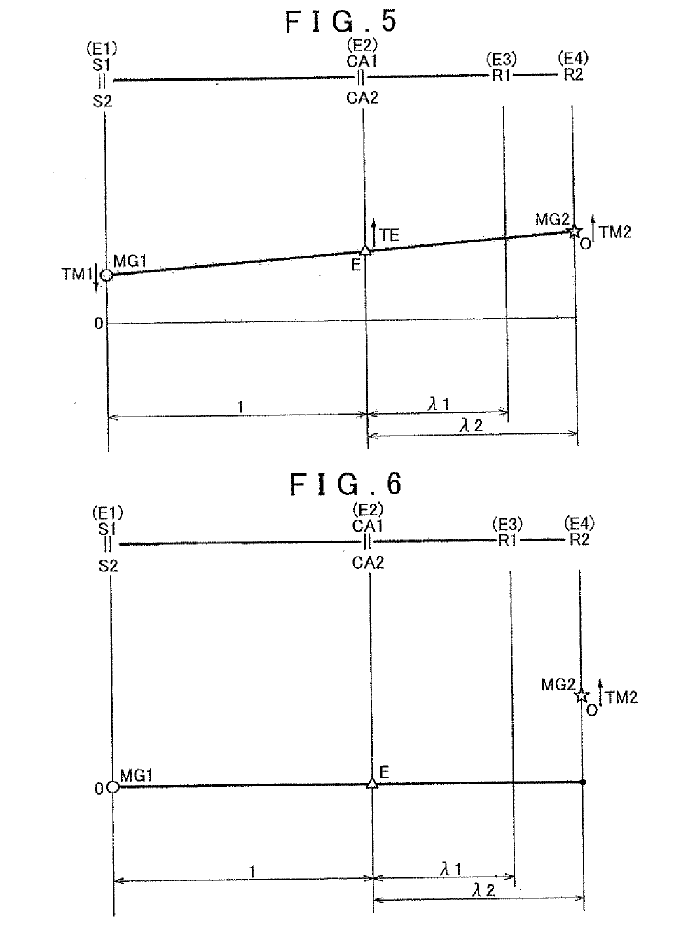

FIGS. 4 to 8 are velocity diagrams of the differential gear unit DG (the first differential gear unit DG1 and the second differential gear unit DG2) of the hybrid drive device H. FIG. 4 is a velocity diagram in the series mode, FIG. 5 is a velocity diagram in the split mode, FIGS. 6 and 7 are velocity diagrams in the electric travel mode, and FIG. 8 is a velocity diagram in the internal combustion engine start mode. In these velocity diagrams, the ordinate corresponds to the rotating speed of each rotating element. That is, “0” on the ordinate indicates that the rotational speed is zero, and the upper side is positive, and the lower side is negative. A plurality of vertical lines shown in parallel correspond to the rotating elements of the differential gear unit DG (the first differential gear unit DG1 and the second differential gear unit DG2). In these velocity diagrams, “◯” indicates the rotational speed of the first rotating electrical machine MG1, “Δ” indicates the rotational speed of the input shaft I (the internal combustion engine E), “⋆” indicates the rotational speed of the output shaft O and the second rotating electrical machine MG2, and “X” indicates the fixed state to the case De by the two-way clutch F1.

The gaps between the vertical lines corresponding to the rotating elements correspond to the gear ratio λ1 of the planetary gear mechanism of the first differential gear unit DG1, and the gear ratio λ2 of the planetary gear mechanism of the second differential gear unit DG2. These gear ratios λ1, λ2 are shown at the bottom of FIGS. 4 to 8. Note that specific values of the gear ratios λ1, λ2 can be determined as appropriate in view of characteristics of the internal combustion engine E, the first rotating electrical machine MG1 and the second rotating electrical machine MG2, the vehicle weight, and the like. The operating state of the hybrid drive device H in each operation mode will be described in detail below.

1-3-1. Series Mode

The series mode is a mode in which the torque TM2 of the second rotating electrical machine MG2, which is output by consuming electric power generated by the first rotating electrical machine MG1 by torque TE of the input shaft I (the internal combustion engine E), is transmitted to the output shaft O. In the present embodiment, as shown in FIG. 3, the series mode is implemented by the two-way clutch F1 in the two-way engaged state, and the one-way clutch F2 in the disengaged state. That is, the series mode is implemented in the state in which, with the two-way clutch F1 in the two-way engaged state, rotation of the first ring gear R1 of the first differential gear unit DG1 (the third rotating element E3 of the differential gear unit DG) is stopped, and also the output shaft O rotates in the positive direction relative to the second ring gear R2 of the second differential gear unit DG2 (the fourth rotating element E4 of the differential gear unit DG), and the one-way clutch F2 is disengaged. In the present embodiment, the series mode includes a series forward travel mode as one form, and a series rearward travel mode as another form. Note that when the general term “series mode” is used in the following description, the term refers to both the series forward travel mode and the series rearward travel mode.

In the present embodiment, the velocity diagrams of the differential gear unit DG (the first differential gear unit DG1 and the second differential gear unit DG2) are the same both in the series forward travel mode and the series rearward travel mode, except the rotating speed of the output shaft O and the second rotating electrical machine MG2. That is, as shown in FIG. 4, each rotating element of the differential gear unit DG is maintained in a constant rotating state, and the series forward travel mode is implemented in the state in which the rotational speed of the output shaft O and the second rotating electrical machine MG2 is positive, whereas the series rearward travel mode is implemented in the state in which the rotational speed of the output shaft O and the second rotating electrical machine MG2 is negative.

As shown in the velocity diagrams of FIG. 4, in the series mode, the state of the differential gear unit DG is determined based on the rotating state of three of the four rotating elements of the differential gear unit DG, namely the integral sun gear S (the first rotating element E1), the integral carrier CA (the second rotating element E2), and the first ring gear R1 (the third rotating element E3). That is, of these three rotating elements, the first ring gear R1, which is located on one side in order of the rotational speed, is fixed to the case Dc by the two-way clutch F1, and the input shaft I is drivingly coupled to the integral carrier CA that is located in the middle in order of the rotational speed. The rotor Ro1 of the first rotating electrical machine MG1 is drivingly coupled to the integral sun gear S that is located on the other side in order of the rotational speed. In this state, the first rotating electrical machine MG1, which rotates in the positive direction by the torque TE of the input shaft I (the internal combustion engine E) in the positive direction, outputs torque TM1 in the negative direction. Thus, the first rotating electrical machine MG1 outputs the torque TM1 in the negative direction and generates electric power, while rotating in the positive direction.

In this state, the second rotating electrical machine MG2 outputs torque TM2 in the positive direction and rotates in the positive direction, whereby the series forward travel mode is implemented (see FIG. 3). In the present embodiment, regarding the gear ratios of the first differential gear unit DG1 and the second differential gear unit DG2 of the differential gear unit DG, the gear ratio λ2 of the second differential gear unit DG2 is set to a value larger than the gear ratio λ1 of the first differential gear unit DG1. Thus, during forward traveling of the vehicle during which the output shaft O and the second rotating electrical machine MG2, which rotate together, have a positive rotational speed (including during stopping of the vehicle during which the rotational speed of the output shaft O is zero), the second ring gear R2 (the fourth rotating element E4), which is located on one side of the first ring gear R1 (the third rotating element E3) in order of the rotational speed, has a negative rotational speed, which is always lower than the rotational speed of the output shaft O. Thus, in the series forward travel mode, the output shaft O always rotates in the positive direction relative to the second ring gear R2, and the one-way clutch F2 is disengaged, whereby torque transmission between the input shaft I (the internal combustion engine E) and the output shaft O is cut off. In this state, the torque TM2 in the positive direction, which is output from the second rotating electrical machine MG2, is transmitted to the output shaft O whereby the vehicle travels forward. At this time, the second rotating electrical machine MG2 is powered by consuming the electric power generated by the first rotating electrical machine MG1. Note that during deceleration of the vehicle, the second rotating electrical machine MG2 rotates in the positive direction and outputs torque TM2 in the negative direction, thereby performing a regenerative braking operation and generating electric power.

On the other hand, the series forward travel mode is implemented when the second rotating electrical machine MG2 outputs torque TM2 in the negative direction and rotates in the negative direction in the state where the first rotating electrical machine MG1 rotates in the positive direction and outputs torque TM1 in the negative direction to generate electric power (see FIG. 3). As described above, during rearward traveling at a very low speed at which the rotational speed of the second ring gear R2 (the fourth rotating element E4) is negative, and the absolute value of the rotational speed of the output shaft O is equal to or lower than a predetermined value, the rotational speed of the output shaft O is higher than that of the second ring gear R2 (the absolute value is smaller). Thus, during traveling at the very low speed as described above, the output shaft O rotates in the positive direction relative to the second gear R2, and the one-way clutch F2 is disengaged, whereby rearward traveling in the series mode can be implemented. That is, in the state in which torque transmission between the input shaft I (the internal combustion engine E) and the output shaft O is cut off, the torque TM2 in the negative direction, which is output from the second rotating electrical machine MG2, is transmitted to the output shaft O, whereby the vehicle travels rearward. At this time, the second rotating electrical machine MG2 is powered by consuming the electric power generated by the first rotating electrical machine MG1. In this case, the vehicle speed range in which the vehicle can move rearward at a low speed corresponds to a rotational speed range from the rotational speed or higher of the second ring gear R2, which is determined by the differential gear unit DG based on the rotational speed of the integral carrier CA drivingly coupled to the input shaft, to zero or lower. In FIG. 4, the range of the vehicle speed (the rotational speed of the output shaft O) in which traveling in the series rearward travel mode is possible is shown by a thick arrow. Note that during deceleration of the vehicle, the second rotating electrical machine MG2 rotates in the negative direction and outputs torque TM2 in the positive direction, thereby performing a regenerative braking operation and generating electric power.

The hybrid drive device H of the present embodiment has such a series rearward travel mode. Thus, the vehicle can travel rearward by the torque TM2 of the second rotating electrical machine MG2 in the state in which the first rotating electrical machine MG1 is generating electric power by the torque TE of the input shaft I (the internal combustion engine E). Accordingly, the vehicle can travel rearward regardless of the amount of charge in the battery 21, and a sufficient range can be ensured when the vehicle travels rearward. Moreover, in the series rearward travel mode, the first rotating electrical machine MG1 generates electric power by the torque TE of the internal combustion engine E, and the second rotating electrical machine MG2 is powered by consuming the electric power generated by the first rotating electrical machine MG1. Thus, a sufficient driving force by the torque TM2 of the second rotating electrical machine MG2 can be ensured regardless of the environments in which the battery 21 is used, for example, even in, e.g., cold environments. Moreover, in the series rearward travel mode, the vehicle can travel rearward by the torque TM2 of the second rotating electrical machine MG2 in the state in which torque transmission between the input shaft I (the internal combustion engine E) and the output shaft O is cut off, whereby transmission of vibrations of the internal combustion engine E to the output shaft O can be reduced. Thus, comfort of the occupants can be satisfactorily maintained. This structure is especially advantageous when the inner combustion engine E drivingly coupled to the input shaft I is structured to have characteristics that tend to generate vibrations in a low rotational speed range, such as a small number of cylinders. Note that in such a series rearward travel mode, the vehicle speed range in which the vehicle can travel rearward is limited to a predetermined speed range, but this does not cause any problem as the vehicle speed normally does not increase so much (does not reduce significantly in the negative direction) during rearward traveling.

1-3-2. Split Mode

The split mode is a mode in which the torque TE of the input shaft I (the internal combustion engine E) is transmitted to the output shaft O while being distributed to the first rotating electrical machine MG1. In the present embodiment, as shown in FIG. 3, the split mode is implemented by the two-way clutch F1 in the disengaged state and the one-way clutch F2 in the engaged state. That is, the split mode is implemented in the state in which the first ring gear R1 of the first differential gear unit DG1 (the third rotating element E3 of the differential gear unit DG) is allowed to rotate in the disengaged state of the two-way clutch F1, while the output shaft O attempts to rotate in the negative direction relative to the second ring gear R2 of the second differential gear unit DG2 (the fourth rotating element E4 of the differential gear unit DG), and the one-way clutch F2 is engaged, whereby the second ring gear R2 is drivingly coupled to the output shaft O so as to rotate therewith by the one-way clutch F2. In the present embodiment, the split mode is a split forward travel mode in which the vehicle travels forward.

As shown in the velocity diagram of FIG. 5, in the split mode, the state of the differential gear unit DG is determined based on the rotating state of three of the four rotating elements of the differential gear unit DG, namely the integral sun gear S (the first rotating element E1), the integral carrier CA (the second rotating element E2), and the second ring gear R2 (the fourth rotating element E4). That is, of these three rotating elements, the input shaft I is drivingly coupled to the integral carrier CA that is located in the middle in order of the rotational speed, and the rotor Ro1 of the first rotating electrical machine MG1 is drivingly coupled to the integral sun gear S that is located on one side in order of the rotational speed. In this state, the output shaft O rotates in the negative direction relative to the second ring gear R2 that is located on the other side in order of the rotational speed, whereby the one-way clutch F2 is engaged, and the second ring gear R2 and the output shaft O are drivingly coupled together so as to integrally rotate.

In the split mode, the torque TE of the input shaft I (the internal combustion engine E) is transmitted to the integral carrier CA that is drivingly coupled to the input shaft I so as to integrally rotate therewith. At this time, the internal combustion engine E outputs the torque TE in the positive direction according to the required driving force, while being controlled so as to be maintained in an efficient, low emission state (a state according to optimal fuel consumption characteristics), and the torque TE is transmitted to the integral carrier CA via the input shaft I. The torque TE of the input shaft (the internal combustion engine E) transmitted to the integral carrier CA is attenuated by the differential gear unit DG and transmitted to the second ring gear R2. That is, in the differential gear unit DG, the torque TE of the input shaft I (the internal combustion engine E) is applied to the integral carrier CA that is located in the middle in order of the rotational direction, and the torque TM1 of the first rotating electrical machine MG1 is applied to the integral sun gear S that is located on one side in order of the rotational speed. At this time, the first rotating electrical machine MG1 outputs the torque TM1 in the negative direction, and functions to receive a reaction force of the torque TE of the input shaft I (the internal combustion engine E). Thus, the second differential gear unit PG2 distributes to the first rotating electrical machine MG1 a part of the torque TE of the input shaft I (the internal combustion engine E) transmitted to the integral carrier CA, and transmits the torque attenuated with respect to the torque TE of the input shaft I (the internal combustion engine E) to the second ring gear R2. At this time, the first rotating electrical machine MG1 rotates in the positive direction, and outputs the torque TM1 in the negative direction to generate electric power.

In this state, the second rotating electrical machine MG2 outputs the torque TM2 in the positive direction and rotates in the positive direction (see FIG. 3). The torque TM2 that is output from the second rotating electrical machine MG2 is smaller than that corresponding to the running resistance of the vehicle. Thus, the first rotating electrical machine MG1 rotates in the positive direction and outputs the torque TM1 in the negative direction, and the second rotating electrical machine MG2 rotates in the positive direction and outputs the torque TM2 in the positive direction, which is smaller than that corresponding to the running resistance of the vehicle. Accordingly, the rotational speed of the second ring gear R2 attempts to change in the positive direction via the differential gear unit DG, and the rotational speed of the output shaft O attempts to change in the negative direction. Thus, the output shaft O attempts to rotate in the negative direction relative to the second ring gear R2, and the one-way clutch F2 is engaged, whereby the second ring gear R2 and the output shaft O are drivingly coupled so as to integrally rotate. As described above, in the split mode, the torque in the positive direction, which is transmitted to the second ring gear R2 of the second differential gear unit DG2 (the fourth rotating element E4 of the differential gear unit DG) out of the torque TE of the input shaft I (the internal combustion engine E), is transmitted to the output shaft O via the one-way clutch F2, and the torque TM2 of the second rotating electrical machine MG2 in the positive direction is transmitted to the output shaft O, whereby the vehicle travels forward. At this time, the second rotating electrical machine MG2 is powered by consuming electric power generated by the first rotating electrical machine MG1. Note that during deceleration of the vehicle, the second rotating electrical machine MG2 rotates in the positive direction and outputs the torque TM2 in the negative direction, thereby performing a regenerative braking operation and generating electric power.

Note that if the vehicle speed (the rotational speed of the output shaft O) becomes higher than a predetermined value, the first rotating electrical machine MG1 is powered by rotating in the negative direction and generating the torque TM1 in the negative direction. In this case, the second rotating electrical machine MG2 rotates in the positive direction and outputs the torque TM2 in the negative direction to generate electric power, in order to generate electric power for powering the first rotating electrical machine MG1. In this case as well, the second ring gear R2 and the output shaft O are drivingly coupled together so as to integrally rotate.

1-3-3. Electric Travel Mode

The electric travel mode is a mode in which, of the internal combustion engine E, the first rotating electrical machine MG1, and the second rotating electrical machine MG2, only the second rotating electrical machine MG2 outputs torque, and the torque TM2 of the second rotating electrical machine MG2 is transmitted to the output shaft O. In the present embodiment, the electric travel mode includes an electric forward travel mode as one form, and an electric rearward travel mode as another form. In the present embodiment, as shown in FIG. 3, the electric forward travel mode is implemented by the two-way clutch F1 and the one-way clutch F2 both in the disengaged state. That is, the electric forward travel mode is implemented in the state in which the two-way clutch F1 is in the disengaged state, and the first ring gear R1 of the first differential gear unit DG1 (the third rotating element E3 of the differential gear unit DG) is allowed to rotate, while the output shaft O rotates in the positive direction relative to the second ring gear R2 of the second differential gear unit DG2 (the fourth rotating element E4 of the differential gear unit DG), and the one-way clutch F2 is disengaged. As shown in FIG. 3, the electric rearward travel mode is implemented by the two-way clutch F1 in the disengaged state and the one-way clutch F2 in the engaged state. That is, the electric rearward travel mode is implemented in the state in which the two-way clutch F2 is in the disengaged state, and the first ring gear R1 of the first differential gear unit DG1 (the third rotating element E3 of the differential gear unit DG) is allowed to rotate, while the output shaft O attempts to rotate in the negative direction relative to the second ring gear R2 of the second differential gear unit DG2 (the fourth rotating element E4 of the differential gear unit DG), and the one-way clutch F2 is engaged, whereby the second ring gear R2 is drivingly coupled to the output shaft O by the one-way clutch F2 so as to integrally rotate with the output shaft O. Note that when the general term “electric travel mode” is used in the following description, it refers to both the electric forward travel mode and the electric rearward travel mode.

In the present embodiment, as shown in FIGS. 6 and 7, the velocity diagram of the differential gear unit DG (the first differential gear unit DG1 and the second differential gear unit DG2) in the electric forward travel mode is different from that of the differential gear unit DG in the electric rearward travel mode. Note that FIG. 6 shows the velocity diagram of the differential gear unit DG in the electric forward travel mode, and FIG. 7 shows the velocity diagram of the differential gear unit DG in the electric rearward travel mode. Note that the electric forward travel mode and the electric rearward travel mode are common in that substantially no torque is transmitted via the differential gear unit DG. That is, in the electric travel mode, only the torque TM2 of the second rotating electrical machine MG2 drivingly coupled to the output shaft O so as to rotate therewith is transmitted to the output shaft O, and no torque is transmitted via the differential gear unit DG.

As shown in the velocity diagram of FIG. 6, in the electric forward travel mode, the first rotating electrical machine MG1 is stopped, and the rotational speed of the integral sun gear S drivingly coupled thereto is substantially zero. The internal combustion engine E is also stopped, and the rotational speed of the input shaft I and the integral carrier CA drivingly coupled thereto is also maintained at substantially zero. Thus, during forward traveling of the vehicle during which the rotational speed of the second ring gear R2 is also maintained at substantially zero, and the rotational speed of the output shaft O is positive, the output shaft O rotates in the positive direction relative to the second ring gear R2, and the one-way clutch F2 is disengaged. In this state, the torque TM2 in the positive direction and rotation in the positive direction, which are output from the second rotating electrical machine MG2, are transmitted to the output shaft O, whereby the vehicle travels forward. At this time, the second rotating electrical machine MG2 is powered by consuming the electric power stored in the battery 21. Note that during deceleration of the vehicle, the second rotating electrical machine MG2 rotates in the positive direction and outputs the torque TM2 in the negative direction, thereby performing a regenerative braking operation and generating electric power.

On the other hand, as shown in the velocity diagram of FIG. 7, in the electric rearward travel mode, the internal combustion engine E is stopped, and the rotational speed of the input shaft I and the integral carrier CA drivingly coupled thereto is maintained at substantially zero. The first rotating electrical machine MG1 also output no torque TM1. Thus, during rearward traveling of the vehicle during which the rotational speed of the output shaft O becomes negative in an attempt to maintain the rotational speed of the second ring gear R2 at substantially zero, the output shaft O attempts to rotate in the negative direction relative to the second ring gear R2, and the one-way clutch F2 is engaged. Thus, the second ring gear R2 and the output shaft O are drivingly coupled together so as to integrally rotate. In this state, the torque TM2 in the negative direction and rotation in the negative direction, which are output from the second rotating electrical machine MG2, are transmitted to the output shaft O, whereby the vehicle travels rearward. At this time, the second rotating electrical machine MG2 is powered by consuming the electric power stored in the battery 21. Note that as the output shaft O integrally rotates in the negative direction with the second ring gear R2, the first rotating electrical machine MG1 idles in the positive direction. During deceleration of the vehicle, the second rotating electrical machine MG2 rotates in the negative direction and outputs the torque TM2 in the positive direction, thereby performing a regenerative braking operation and generating electric power.

1-3-4. Internal Combustion Engine Start Mode

The internal combustion engine start mode is a mode in which the internal combustion engine E is started by the torque TM1 of the first rotating electrical machine MG1. In the present embodiment, as shown in FIG. 3, the internal combustion engine start mode is implemented by the two-way clutch F1 in the two-way engaged state and the one-way clutch F2 in the disengaged state. That is, the internal combustion engine start mode is implemented in the state in which the two-way clutch F1 is in the two-way engaged state, and rotation of the first ring gear R1 of the first differential gear unit DG1 (the third rotating element E3 of the differential gear unit DG) is stopped, while the output shaft O rotates in the positive direction relative to the second ring gear R2 of the second differential gear unit DG2 (the fourth rotating element E4 of the differential gear unit DG), and the one-way clutch F2 is disengaged.

As shown in the velocity diagram of FIG. 8, in the internal combustion engine start mode, the state of the differential gear unit DG is determined based on the rotating state of three of the four rotating elements of the differential gear unit DG, namely the integral sun gear S (the first rotating element E1), the integral carrier CA (the second rotating element E2), and the first ring gear R1 (the third rotating element E3). That is, of these three rotating elements, the first ring gear R1, which is located on one side in order of the rotational speed, is fixed to the case Dc as the non-rotating member by the two-way clutch F1, and the input shaft I is drivingly coupled to the integral carrier CA located in the middle in order of the rotational speed. The first rotating electrical machine MG1 is drivingly coupled to the integral sun gear S that is located on the other side in order of the rotational speed. Thus, since the first rotating electrical machine MG1 outputs the torque TM1 in the positive direction and changes the rotational speed to the positive direction, thereby increasing the rotational speed of the internal combustion engine E drivingly coupled to the integral carrier CA via the input shaft I so as to integrally rotate with the integral carrier CA. The internal combustion engine E can be started in this manner. In the present embodiment, implementing the internal combustion engine start mode enables the internal combustion engine E to be started while the vehicle is stopped or is moving in the electric forward travel mode.

1-4. Switching of Modes

Switching of the modes will be described below. As described above, in the present embodiment, one of the series mode, the split mode, and the electric travel mode is selected during normal traveling of the vehicle. For example, the electric travel mode can be selected upon starting of the vehicle; and the series mode can be selected if the amount of charge in the battery 21 decreases to a predetermined value or less during traveling in the electric travel mode. The split mode can be selected if, e.g., the required driving force cannot be obtained only by the torque TM2 of the second rotating electrical machine MG2, and the electric travel mode can be selected if the required driving force decreases during traveling in the split mode. Thus, switching between the series mode and the split mode and between the electric travel mode and the split mode during forward traveling of the vehicle will be described below as an example. Note that the conditions for selecting the mode are shown by way of example only, and the mode can be selected based on various other conditions.

1-4-1. Switching between Series Mode and Split Mode

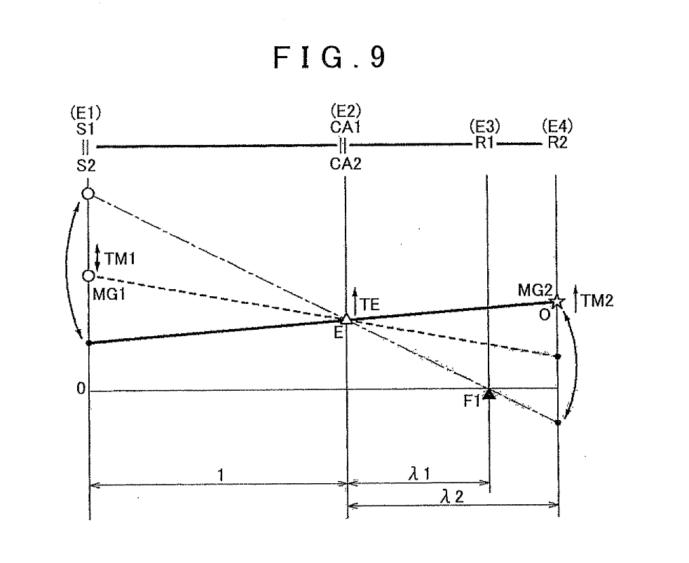

FIG. 9 is a velocity diagram showing a process of switching between the series mode and the split mode. When switching the mode from the split mode to the series mode, the two-way clutch F1 is engaged, and the one-way clutch F2 is disengaged.

Specifically, the two-way clutch F1 is in the two-way engaged state, and the one-way clutch F2 is in the disengaged state. As described above, in the split mode, the two-way clutch F1 is in the disengaged state, and the first ring gear R is allowed to rotate, while the output shaft O attempts to rotate in the negative direction relative to the second ring gear R2, and the one-way clutch F2 is engaged, whereby the second ring gear R2 is drivingly coupled to the output shaft O by the one-way clutch F so as to integrally rotate with the output shaft O. In this state, the switch control portion 43 first brings the two-way clutch F1 into the one-way engaged state via the switch control device 35. When the two-way clutch F1 is in the one-way engaged state, the first ring gear R1 is allowed to rotate in the positive direction, but is restricted from rotating in the negative direction. In FIG. 9, the one-way engaged state of the two-way clutch F1 is schematically shown by a black triangle.

Then, the internal combustion engine E and the first rotating electrical machine MG1 are controlled in terms of the rotational speed and the torque TM1 via the internal combustion engine control unit 32 and the first rotating electrical machine control unit 33 to change the rotational speed of the first ring gear R1 of the first differential gear unit DG1 to the negative direction. In the present embodiment, the first rotating electrical machine MG1 is caused to output the torque TM1 in the positive direction to increase the rotational speed of the first rotating electrical machine MG1, while maintaining the rotational speed of the input shaft I (the internal combustion engine E) at a substantially constant value. Thus, with the input shaft I and the integral carrier CA drivingly coupled thereto as a fulcrum, the rotational speed of the first rotating electrical machine MG1 and the integral sun gear S drivingly coupled thereto changes to the positive direction, and the rotational speed of the first ring gear R1 changes to the negative direction while the first ring gear R1 rotates in the positive direction. At this time, since the rotational speed of the second ring gear R2 also changes to the negative direction, the output shaft O, whose rotational speed is maintained at a substantially constant value, rotates in the positive direction relative to the second ring gear R2, whereby the one-way clutch F2 is disengaged. If the rotational speed of the first rotating electrical machine MG1 is increased to continuously reduce the rotational speed of the first ring gear R1, the rotational speed of the first ring gear R1 eventually reduces to zero, and the first ring gear R1 attempts to rotate in the negative direction. At this time, the two-way clutch F1 is in the one-way engaged state, and the first ring gear R1 is restricted from rotating in the negative direction, whereby the rotational speed of the first ring gear R1 is forcibly restricted to zero.

Then, the switch control portion 43 brings the two-way clutch F1 into the two-way engaged state via the switch control device 35 to restrict rotation of the first ring gear R1 in both directions, thereby stopping rotation of the first ring gear R1. The direction of the torque TM1 of the first rotating electrical machine MG1 is switched from the positive to negative direction, and the first rotating electrical machine MG1 is caused to output the torque TM1 of the magnitude required to ensure a desired amount of electric power generation. The mode is switched from the split mode to the series mode in this manner. At this time, the mode is switched by merely controlling the rotational speed and the torque TM1 of the first rotating electrical machine MG1 without specifically controlling the rotational speed of the second rotating electrical machine MG2 drivingly coupled to the output shaft O that is maintained at a substantially constant speed according to the vehicle speed. Thus, in the hybrid drive device H of the present embodiment, the mode can be switched from the split mode to the series mode by controlling the first rotating electrical machine MG1 in a relatively simple manner.

When switching the mode from the series mode to the split mode, the two-way clutch F1 is released from the engaged state, and placed in the disengaged state, and the one-way clutch F2 is engaged and placed in the engaged state. As described above, in the series mode, the two-way clutch F1 is in the two-way engaged state, and rotation of the first ring gear R is stopped, while the output shaft O rotates in the positive direction relative to the second ring gear R2, and the one-way clutch F2 is disengaged, In this state, the switch control portion 43 first brings the two-way clutch F1 into the disengaged state via the switch control device 35.

Then, the internal combustion engine E and the first rotating electrical machine MG1 are controlled in terms of the rotational speed and the torque TM1 via the internal combustion engine control unit 32 and the first rotating electrical machine control unit 33 to change the rotational speed of the second ring gear R2 of the second differential gear unit DG2 to the positive direction. In the present embodiment, the torque TM1 in the negative direction, which is output from the first rotating electrical machine MG1 in the series mode, is maintained as it is, and the rotational speed of the first rotating electrical machine MG1 is reduced, while maintaining the rotational speed of the input shaft I (the internal combustion engine E) at a substantially constant value. If the rotational speed of the first rotating electrical machine MG1 continues to be decreased, the rotational speed of the second ring gear R2 changes to the positive direction with the input shaft I and the integral carrier CA drivingly coupled thereto as a fulcrum. The rotational speed of the output shaft O relative to the second ring gear R2 eventually decreases to zero, and the second ring gear R2 attempts to rotate in the positive direction relative to the output shaft O, whereby the one-way clutch F2 is engaged, and the second ring gear R2 is drivingly coupled to the output shaft O so as to integrally rotate therewith.

Then, while maintaining the direction of the torque TM1 of the first rotating electrical machine MG1 in the negative direction, the first rotating electrical machine MG1 is caused to output the torque TM1 of the magnitude required to support a reaction force of the torque TE of the input shaft I (the internal combustion engine E). The mode is switched from the series mode to the split mode in this manner. At this time, the mode is switched by merely controlling the rotational speed and the torque TM1 of the first rotating electrical machine MG1 without specifically controlling the rotational speed of the second rotating electrical machine MG2 that is drivingly coupled to the output shaft O that is maintained at a substantially constant speed according to the vehicle speed. Thus, in the hybrid drive device H of the present embodiment, the mode can be switched from the series mode to the split mode by controlling the first rotating electrical machine MG1 in a relatively simple manner.

1-4-2. Switching between Electric Travel Mode and Split Mode

When switching the mode from the split mode to the electric travel mode, the one-way clutch F2 is released from the engaged state, and placed in the disengaged state. As described above, in the split mode, the two-way clutch F1 is in the disengaged state, and the first ring gear R1 is allowed to rotate. Further, the output shaft O attempts to rotate in the negative direction relative to the second ring gear R2, and the one-way clutch F2 is engaged, whereby the second gear R2 is drivingly coupled to the output shaft O by the one-way clutch F2 so as to integrally rotate therewith. In the present embodiment, in this state, the switch control portion 43 first brings the two-way clutch F1 into the one-way engaged state via the switch control device 35 so that the internal combustion engine E can be quickly started in the event of a request to start the internal combustion engine E. When the two-way clutch F1 is in the one-way engaged state, the first ring gear R1 is allowed to rotate in the positive direction, but is restricted from rotating in the negative direction. Thereafter, rotation of the internal combustion engine E and the first rotating electrical machine MG1 is stopped. Thus, the rotational speed of each rotating element of the differential gear unit DG becomes zero, and the output shaft O rotates in the positive direction relative to the second ring gear R2, whereby the mode is switched from the split mode to the electric travel mode.

When switching the mode from the electric travel mode to the split mode, the one-way clutch F2 is engaged and placed in the engaged state. As described above, in the electric travel mode, the two-way clutch F1 is in the disengaged state, and the first ring gear R1 is allowed to rotate, while the output shaft O rotates in the positive direction relative to the second ring gear R2, and the one-way clutch F2 is disengaged. In the present embodiment, in this state, the switch control portion 43 first brings the two-way clutch F1 into the two-way engaged state via the switch control device 35. In this state, the first rotating electrical machine MG1 is caused to output the torque TM1 in the positive direction to change the rotational speed to the positive direction, whereby the rotational speed of the internal combustion engine E that is drivingly coupled to the input shaft I so as to rotate therewith is increased to start the internal combustion engine E. After the internal combustion engine E is started, the direction of the torque TM1 of the first rotating electrical machine MG1 is switched from the positive direction to the negative direction, and the first rotating electrical machine MG1 is caused to output the torque TM1 of the magnitude required to support a reaction force of the torque TE of the input shaft I (the internal combustion engine E). Moreover, the switch control portion 43 brings the two-way clutch F1 into the disengaged state via the switch control device 35. Thus, the mode is switched from the electric travel mode to the split mode.

Note that if the two-way clutch F1 is brought into the one-way engaged state as described above when switching the mode from the split mode to the electric travel mode, the two-way clutch F1 that is brought into the one-way engaged state in the mode switching process may be maintained in the one-way engaged state during traveling in the electric travel mode and when switching from the electric travel mode to the split mode. Even if the two-way clutch F1 is in the one-way engaged state, the internal combustion engine E can be started appropriately as the first ring gear R1 is restricted from rotating at least in the negative direction.

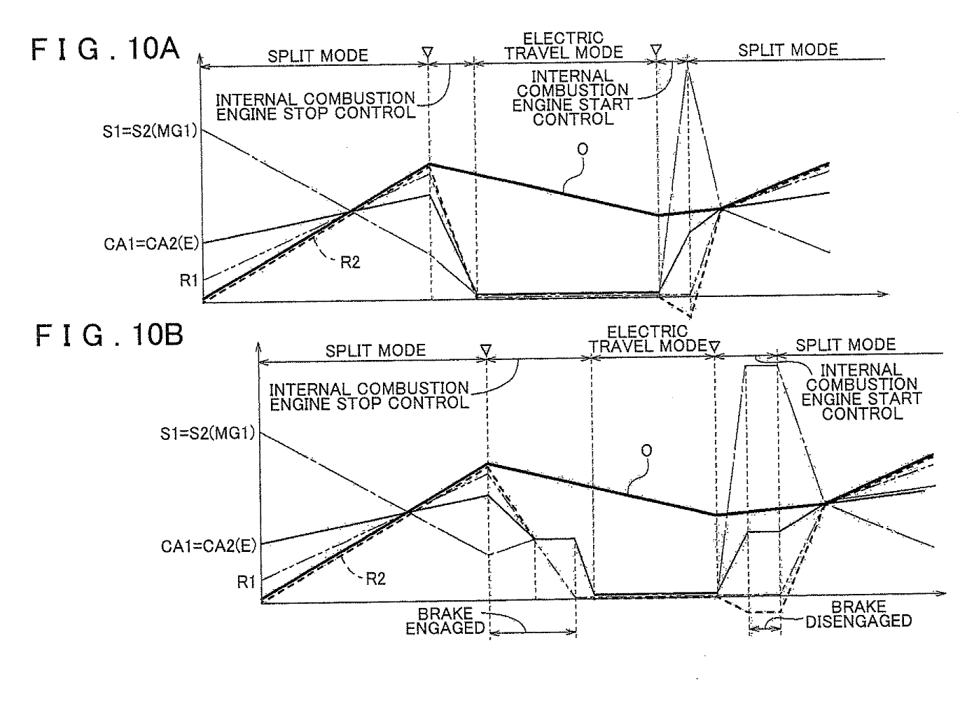

In the present embodiment, the two-way clutch F1 is used as the rotation restricting device as described above. By employing the structure that uses the two-way clutch F1, switching from the split mode to the electric travel mode and switching from the electric travel mode to the split mode can be easily and quickly performed as compared to the case of employing the structure that uses a friction engagement brake that is widely used in common vehicle drive devices. This will be described below with reference to FIGS. 10A and 10B. FIGS. 10A and 10B are timing charts illustrating a mode switching process in which the vehicle travels by switching the mode in order of the split mode, the electric travel mode, and again the split mode. Note that FIG. 10A is a timing chart in the case where the two-way clutch F1 is used as the rotation restricting device, and FIG. 10B is a timing chart in the case where a friction engagement brake is used as the rotation restricting device.

In these timing charts, the ordinate and the abscissa represent the rotational speed and the time, respectively, and the timing charts show how the rotational speeds of each rotating element of the differential gear unit DG and the output shaft O change over time. Note that at the time of implementing the split mode and at the time of implementing the electric travel mode, the rotational speeds of each rotating element of the differential gear unit DG and the output shaft O change in the same manner between the case where the two-way clutch F1 is used and the case where the friction engagement brake is used. On the other hand, when internal combustion engine stop control is executed in the switching process from the split mode to the electric travel mode, and internal combustion engine start control is executed in the switching process from the electric travel mode to the split mode, the rotational speeds of each rotating element of the differential gear unit DG and the output shaft O change in a different manner between the case where the two-way clutch F1 is used and the case where the friction engagement brake is used.

In the internal combustion engine stop control, the internal combustion engine E is eventually stopped so as to switch to the electric travel mode. In the present embodiment, however, for example, the control is performed to stop the internal combustion engine E while appropriately preparing for the case where the required driving force is increased thereafter and the internal combustion engine E needs to be started immediately. That is, in the case where the friction engagement brake is used, the friction engagement brake is engaged while maintaining the state in which the rotational speed of the internal combustion engine E is reduced to a predetermined value, e.g., a value close to an idling speed. When engaging the friction engagement brake, hydraulic oil having a stroke end pressure is supplied into an oil chamber (a cylinder) of the friction engagement brake to fill the gap between a plurality of friction plates, and the rotational speed of the first rotating electrical machine MG1 is controlled to reduce the rotational speed of the first ring gear R1 to a value close to zero, and then the friction engagement brake is engaged (shown as “brake engaged” in FIG. 10B). Note that, in the latter half of the internal combustion engine stop control, FIG. 10B shows only the rotational speed of the integral gear CA (the internal combustion engine E) and the rotational speed of the first ring gear R1, and the rotational speed of the integral sun gear S (the first rotating electrical machine MG1) and the rotational speed of the second ring gear R2 are omitted for clear illustration. When the friction engagement brake is in the engaged state, the first ring gear R1 is fixed to the case Dc. Thus, if a need arises to start the internal combustion engine E, the first rotating electrical machine MG1 is caused to output the torque TM1 in the positive direction to change the rotational speed of the first rotating electrical machine MG1 to the positive direction, whereby the rotational speed of the internal combustion engine E can be increased and the internal combustion engine E can be started.

On the other hand, in the case where the two-way clutch F1 is used as in the present embodiment, the internal combustion engine stop control is performed with the two-way clutch F1 being in the one-way engaged state as described above. In this case, the first ring gear R1 is already restricted from rotating in the negative direction. Thus, if a need arises to start the internal combustion engine E, the first rotating electrical machine MG1 is caused to output the torque TM1 in the positive direction to change the rotational speed to the positive direction. By merely performing this operation, the rotational speed of the internal combustion engine E can be increased with the first ring gear R1 fixed to the case Dc as a fulcrum, and the internal combustion engine E can be started quickly. That is, unlike the case of using the frictional engagement brake, as shown in FIG. 10A, the mode can be quickly switched from the split mode to the electric travel mode without performing any special hydraulic control or the like.

In the internal combustion engine start control, the internal combustion engine E is started so as to switch to the split mode. In the case where the friction engagement brake is used, the first ring gear R1 is fixed to the case Dc with the friction engagement brake in the engaged state. Thus, the hydraulic oil supplied to the oil chamber (the cylinder) of the friction engagement brake needs be drained to disengage the friction engagement brake by the time the mode is actually switched to the split mode after the internal combustion engine E is started (shown by “brake disengaged” in FIG. 10B). On the other hand, in the case where the two-way clutch F1 is used as in the present embodiment, the internal combustion engine start control can be performed with the two-way clutch F1 being in the one-way engaged state as described above. In this case, since the first ring gear R1 is already allowed to rotate in the positive direction, the mode can be switched to the split mode immediately after the internal combustion engine E is started. That is, unlike the case of using the friction engagement brake, as shown in FIG. 10A, the mode can be quickly switched from the electric travel mode to the split mode without waiting for the friction engagement brake to be disengaged.

### 2. Second Embodiment

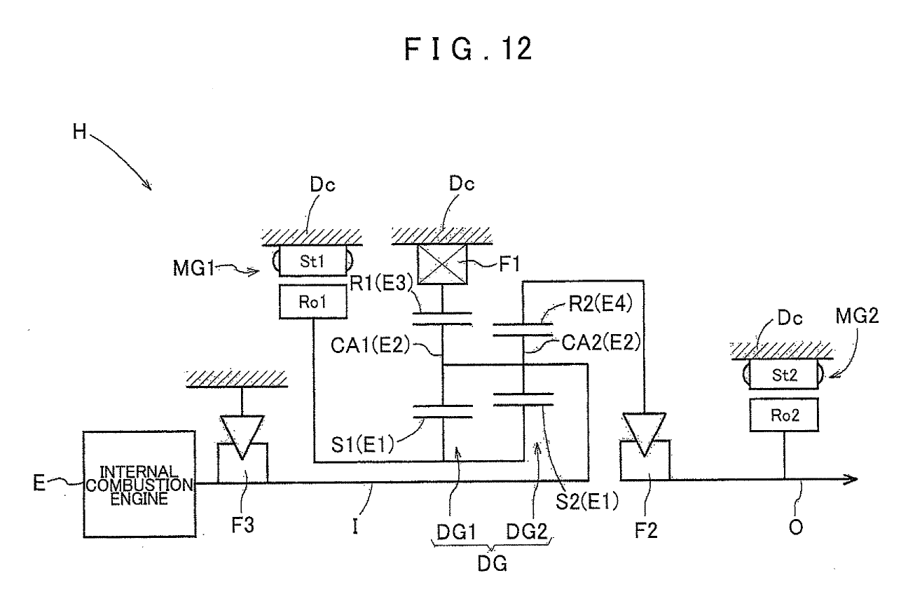

A second embodiment of the present invention will be described below with reference to the accompanying drawings. FIG. 12 is a skeleton diagram showing a mechanical structure of a hybrid drive device H of the present embodiment. Note that as in FIG. 1, the lower half structure that is symmetrical with respect to the central axis is omitted in FIG. 12. The mechanical structure of the hybrid drive device H of the present embodiment is partly different from the first embodiment in that another one-way clutch (a second one-way clutch F3) is added to the structure of the hybrid drive device H of the first embodiment. Since the second one-way clutch F3 is added, the hybrid drive device H of the present embodiment is partly different from that of the first embodiment in that the hybrid drive device H of the second embodiment further includes a second electric travel mode as a switchable mode. The hybrid drive device H of the present embodiment will be described in detail below mainly with respect to the differences from the first embodiment. Note that a first one-way clutch F2 of the present embodiment corresponds to the one-way clutch F2 of the first embodiment, and a first electric travel mode of the present embodiment corresponds to the electric travel mode of the first embodiment. The second embodiment is similar to the first embodiment in the points that are not specified below.

The second one-way clutch F3 is provided between the case De and the input shaft I so as to allow the input shaft Ito rotate only in the positive direction relative to the case Dc as the non-rotating member. That is, the second one-way clutch F3 is provided so as to allow the input shaft I to rotate in the positive direction, and so as to restrict rotation of the input shaft I in the negative direction. For example, if the rotational speed of the input shaft I is continuously changed to the negative direction while the input shaft I is rotating in the positive direction, the second one-way clutch F3 is engaged and the input shaft I is fixed to the case Dc when the rotational speed of the input shaft I becomes zero. In the present embodiment, the second one-way clutch F3 corresponds to a “second rotational direction restricting device” in the present invention. In the present embodiment, the second one-way clutch F3 is positioned between the internal combustion engine E and the first rotating electrical machine MG1 in the axial direction.

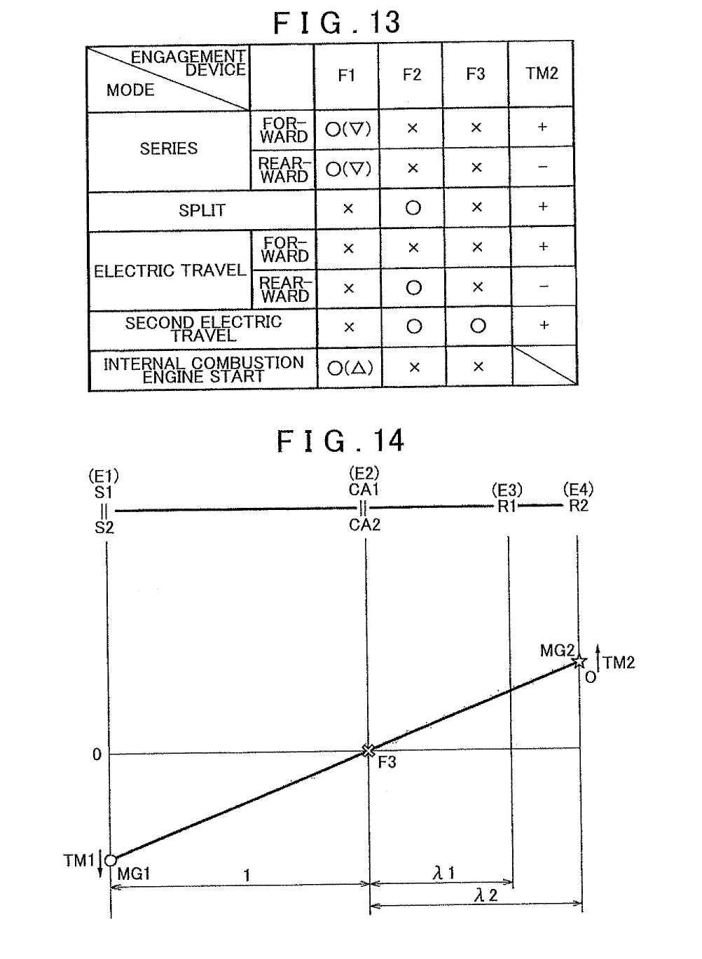

FIG. 13 is an operation table showing the operation state of each engagement device F1, F2, F3 in each mode. This table is shown in a manner similar to that of the table of FIG. 3 in the first embodiment. As shown in FIG. 13, in the present embodiment, the hybrid drive device H includes four switchable modes, namely a “series mode,” a “split mode,” a “first electric travel mode,” and a “second electric travel mode,” as normal travel modes, and further includes an “internal combustion engine start mode.” Thus, the hybrid drive device H of the present embodiment includes a total of five switchable modes.

Note that since the second one-way clutch F3 is in the disengaged state in the series mode, the split mode, the first electric travel mode, and the internal combustion engine start mode of the present embodiment, these modes can be regarded as equivalent to the modes in the first embodiment. Thus, the second electric travel mode, which is specific to the second embodiment, will be described below.

The second electric travel mode is a mode in which both the torque TM1 of the first rotating electrical machine MG1 and the torque TM2 of the second rotating electrical machine MG2 are transmitted to the output shaft O. In the present embodiment, in the second electric travel mode, the direction of the torque TM1 and the rotational direction of the first rotating electrical machine MG1 are reversed and transmitted to the output shaft O, and the torque TM2 of the second electrical machine MG1 is transmitted to the output shaft O as it is. In the present embodiment, as shown in FIG. 13, the second electric travel mode is implemented by the two-way clutch F1 in the disengaged state and the one-way clutch F2 and the one-way clutch F3 in the engaged state. That is, the second electric travel mode is implemented in the following state. The two-way clutch F1 is in the disengaged state, and the first ring gear R1 of the first differential gear unit DG1 (the third rotating element E3 of the differential gear unit DG) is allowed to rotate, while the output shaft O attempts to rotate in the negative direction relative to the second ring gear R2 of the second differential gear unit DG2 (the fourth rotating element E4 of the differential gear unit DG), and the second one-way clutch F3 is engaged, whereby the second ring gear R2 is drivingly coupled to the output shaft O by the one-way clutch F2 so as to integrally rotate with the output shaft O. Moreover, the input shaft I attempts to rotate in the negative direction, and the second one-way clutch F3 is engaged, whereby the input shaft I is fixed to the case Dc by the second one-way clutch F3. In the present embodiment, the second electric travel mode is a second electric forward travel mode in which the vehicle travels forward.

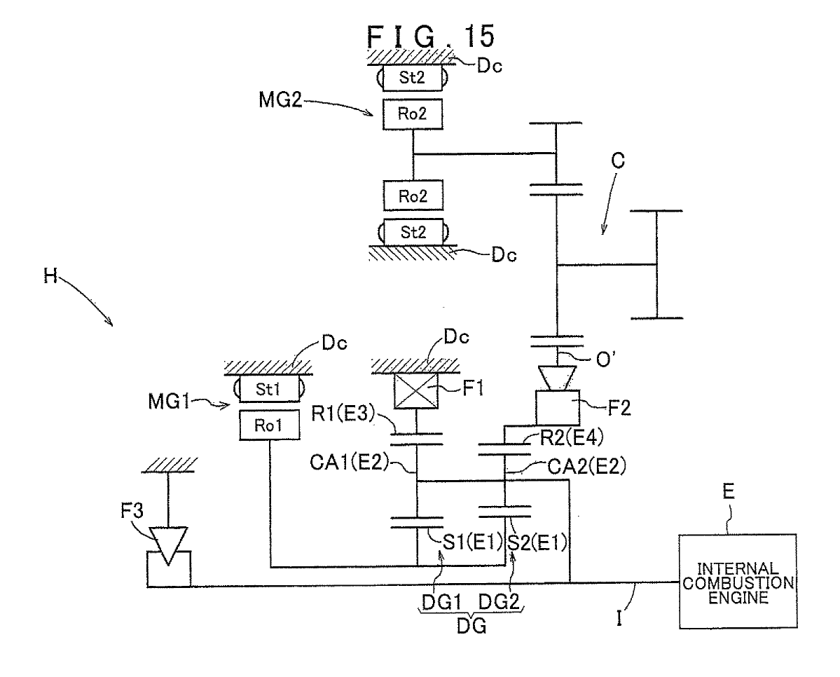

As shown in the velocity diagram of FIG. 14, in the second electric travel mode, the state of the differential gear unit DG is determined based on the rotating state of three of the four rotating elements of the differential gear unit DG, namely, based on the integral sun gear S (the first rotating element E1), the integral carrier CA (the second rotating element E2), and the second ring gear R2 (the fourth rotating element E4). That is, of these three rotating elements, the input shaft I is drivingly coupled to the integral carrier CA that is located in the middle in order of the rotational speed, and the rotor Ro1 of the first rotating electrical machine MG1 is drivingly coupled to the integral sun gear S that is located on one side. In this state, the first rotating electrical machine MG1 rotates in the negative direction, and outputs in the torque TM1 in the negative direction. Thus, the rotational speeds of the integral sun gear S and the integral carrier CA change to the negative direction. When the rotational speed of the integral carrier CA that rotates with the input shaft I becomes zero, the integral carrier CA is fixed to the case Dc by the second one-way clutch F3, and the rotational speed of the integral carrier CA is forcibly restricted to zero. In this case, if the torque TM1 in the negative direction of the first rotating electrical machine MG1 is further applied to the integral sun gear S that is located on one side in order of the rotational speed, the rotational speed of the second ring gear R2 that is located on the other side in order of the rotational speed attempts to change to the positive direction.

In the second electric travel mode, the second rotating electrical machine MG2 outputs the torque TM2 in the positive direction and rotates in the positive direction in this state (see FIG. 3). The torque TM2 that is output from the second rotating electrical machine MG2 is smaller than torque corresponding to the running resistance of the vehicle. Thus, the first rotating electrical machine MG1 rotates in the negative direction and outputs the torque TM1 in the negative direction, and the second rotating electrical machine MG2 rotates in the positive direction and outputs the torque TM2 in the positive direction, which is smaller than torque corresponding to the running resistance of the vehicle. Accordingly, the rotational speed of the second ring gear R2 attempts to change to the positive direction via the differential gear unit DG, and the rotational speed of the output shaft O attempts to change to the negative direction. Thus, the output shaft O attempts to rotate in the negative direction relative to the second ring gear R2, and the one-way clutch F2 is engaged, whereby the second ring gear R2 and the output shaft O are drivingly coupled together so as to integrally rotate. As described above, in the second electric travel mode, the torque TM1 of the first rotating electrical machine MG1 in the negative direction is transmitted to the second ring gear R2 via the first one-way clutch F2 while being reversed by the differential gear unit DG, and the torque TM2 of the second rotating electrical machine MG2 in the positive direction is transmitted to the output shaft O, whereby the vehicle travels forward. At this time, both the first rotating electrical machine MG1 and the second rotating electrical machine MG2 are powered by consuming the electric power stored in the battery 21. Note that during deceleration of the vehicle, the second rotating electrical machine MG2 rotates in the positive direction and outputs the torque TM2 in the negative direction, thereby performing a regenerative braking operation and generating electric power.

Since such a second electric travel mode is provided in the second embodiment, the vehicle can travel appropriately by the torque TM1 of the first rotating electrical machine MG1 and the torque TM2 of the second rotating electrical machine MG2 while maintaining the inner combustion engine E in the stopped state, even when a large driving force is required.

### Other Embodiments

Other embodiments of the hybrid drive device of the present invention will be described below. Note that it is not intended that characteristic structures disclosed in each of the following embodiments be used only in that embodiment. Such characteristic structures can be applied in combination with characteristic structures disclosed in other embodiments unless inconsistencies arise.

(1) The first embodiment is described with respect to an example in which the hybrid drive device H includes the four switchable modes, namely the “series mode,” the “split mode,” the “electric travel mode,” and the “internal combustion engine start mode.” The second embodiment is described with respect to an example in which the hybrid drive device H includes the “second electric travel mode” in addition to the above four modes, and thus includes a total of five switchable modes. However, embodiments of the present invention are not limited to this. That is, it is preferable that the hybrid drive device H include at least the series mode (especially the series rearward travel mode), and it is also one of preferred embodiments of the present invention that the hybrid drive device H include the series mode (the series rearward travel mode), and also include only part of the above four (or five) modes as switchable modes, and that the hybrid drive device H further include modes other than the above four (or five) modes as switchable modes.

(2) The above embodiments are described with respect to an example in which the series mode and the internal combustion engine start mode are implemented by the two-way clutch F1 in the two-way engaged state, and the split mode and the electric travel mode (and also the second electric travel mode in the second embodiment) are implemented by the two-way clutch F1 in the disengaged state. However, embodiments of the present invention are not limited to this. That is, the state of the two-way clutch F1 for implementing each mode can be an appropriate one of the disengaged state, the one-way engaged state, the other-way engaged state, and the two-way engaged state, according to the relation with a possible rotational speed of the first ring gear R1 in each mode. For example, as shown in parentheses in the tables of FIGS. 3 and 13, it is also one of preferred embodiments of the present invention that the two-way clutch F1 be in the one-way engaged state in the internal combustion engine start mode, which is a mode in which the first ring gear R1 should be restricted from rotating in the negative direction, and that the two-way clutch F1 be in the other-way engaged state in the series mode, which is a mode in which the first ring gear R1 should be restricted from rotating in the positive direction. Note that although not shown in the tables of FIGS. 3 and 13, it is also possible that the two-way clutch F1 may be in the one-way engaged state in the split mode and the second electric travel mode, which are modes in which the first ring gear R1 should be allowed to rotate in the positive direction, and that the two-way clutch F1 may be in the other-way engaged state in the (first) electric rearward travel mode, which is a mode in which the first ring gear R1 should be allowed to rotate in the negative direction.

(3) The above embodiments are described with respect to an example of the specific structure of the two-way clutch F1 with reference to the accompanying drawings. However, embodiments of the present invention are not limited to this. That is, the specific structure of the two-way clutch F1 can be changed as appropriate, and it is also one of preferred embodiments of the present invention to form the hybrid drive device H by using a two-way clutch of other structure.

(4) The above embodiments are described with respect to an example in which the two-way clutch F1 can be switched among four states, namely the disengaged state, the one-way engaged state, the other-way engaged state, and the two-way engaged state. However, embodiments of the present invention are not limited to this. That is, it is also preferable that the two-way clutch F1 be switchable among at least three of the four states, as this structure can easily and appropriately implement each of the switchable modes of the hybrid drive device H. In this case, for example, the following structures (A) to (D) may be employed: (A) the structure in which the two-way clutch F1 is switchable among three states, namely the disengaged state, the one-way engaged state, and the two-way engaged state; (B) the structure in which the two-way clutch F1 is switchable among three states, namely the disengaged state, the other-way engaged state, and the two-way engaged state; (C) the structure in which the two-way clutch F1 is switchable among three states, namely the disengaged state, the one-way engaged state, and the other-way engaged state; and (D) the structure in which the two-way clutch F1 is switchable among three states, namely the one-way engaged state, the other-way engaged state, and the two-way engaged state.

Note that the two-way clutch F1 may be switchable among two of the four states. In this case, structures such as (a) and (b) may be used: (a) the structure in which the two-way clutch F1 is switchable between two states, namely the disengaged state and the two-way engaged state; and (b) the structure in which the two-way clutch F1 is switchable between two states, namely the one-way engaged state and the other-way engaged state.

(5) The above embodiments are described with respect to an example in which the first differential gear unit DG1 and the second differential gear unit DG2, which are formed by single-pinion type planetary gear mechanisms, are drivingly coupled so that the first sun gear S1 and the second sun gear S2 integrally rotate with each other and the first carrier CA1 and the second carrier CA2 integrally rotate with each other, and thus the first differential gear unit DG1 and the second differential gear unit DG2 form the four-element differential gear unit DG. However, embodiments of the present invention are not limited to this. That is, the specific structure of the differential gear unit DG can be changed as appropriate as long as the differential gear unit DG has four rotating elements.

(6) The above embodiments are described with respect to an example in which the first rotating electrical machine MG1 and the second rotating electrical machine MG2 are positioned coaxially with the input shaft I. However, embodiments of the present invention are not limited to this. That is, it is also one of preferred embodiments of the present invention that only the first rotating electrical machine MG1 be positioned coaxially with the input shaft I, and the second rotating electrical machine MG2 and the first rotating electrical machine MG1 be positioned on different axes. FIG. 15 shows a structural example of the hybrid drive device H in this case. In the illustrated example, an output gear O′ as an output member is selectively drivingly coupled to the second ring gear R2 of the second differential gear unit DG2 via the one-way clutch F2. Moreover, the second rotating electrical machine MG2 is drivingly coupled to a counter gear mechanism C to which the output gear O′ is drivingly coupled. Thus, the second rotating electrical machine MG2 is drivingly coupled to the output gear O′ via the counter gear mechanism C. In this hybrid drive device H, both the torque that is transmitted to the output gear O′ and the torque TM2 of the second rotating electrical machine MG2 are transmitted toward the wheels W via the counter gear mechanism C and the output differential gear unit DF. Such a structure is suitable as the structure of a hybrid drive device H that is mounted on, e.g., front engine front drive (FF) vehicles. Note that in the present embodiment, the second one-way clutch F3 is positioned on the side opposite to the internal combustion engine E with respect to the first rotating electrical machine MG1 and the two differential gear units DG1, DG2 in the axial direction.

(7) Regarding other structures, the embodiments disclosed in the specification are by way of example only in all respects, and embodiments of the present invention are not limited thereto. That is, it is to be understood that the configurations in which the structures that are not described in the claims are partially modified as appropriate also fall in the technical scope of the present invention, as long as the configurations include the structures described in the claims of the present application and the structures equivalent thereto.

The present invention can be preferably used for hybrid drive devices that include an input member drivingly coupled to an internal combustion engine, a first rotating electrical machine, a second rotating electrical machine, an output member drivingly coupled to wheels and the second rotating electrical machine, and a differential gear unit.

What is claimed is:

1. A hybrid drive device, comprising:
an input member drivingly coupled to an internal combustion engine;
a first rotating electrical machine;
a second rotating electrical machine;
an output member drivingly coupled to wheels and the second rotating electrical machine; and
a differential gear unit, wherein
the differential gear unit has four rotating elements, which are a first rotating element, a second rotating element, a third rotating element, and a fourth rotating element in order of a rotational speed,
the first rotating element of the differential gear unit is drivingly coupled to the first rotating electrical machine,
the second rotating element is drivingly coupled to the input member,
the third rotating element is selectively fixed to a non-rotating member by a rotating restricting device,
the fourth rotating element is selectively drivingly coupled to the output member via a rotational direction restricting device, and
the rotational direction restricting device is provided so as to allow the output member to rotate only in a positive direction relative to the fourth rotating element of the differential gear unit.

2. The hybrid drive device according to claim 1, further comprising:
a series mode that is implemented in a state in which the third rotating element of the differential gear unit is fixed by the rotation restricting device, and the output member rotates in the positive direction relative to the fourth rotating element of the differential gear unit, wherein in the series mode, torque of the second rotating electrical machine, which is output by consumption of electric power generated by the first rotating electrical machine using torque of the input member, is transmitted to the output member; and
a series rearward travel mode, as one form of the series mode, in which torque and rotation of the second rotating electrical machine in a negative direction are transmitted to the output member in a state in which the output member rotates at a rotational speed in a range from a rotational speed or higher of the fourth rotating element of the differential gear unit, which is determined based on a rotational speed of the input member, to zero or lower.

3. The hybrid drive device according to claim 1, further comprising:
a split mode that is implemented in a state in which the fourth rotating element of the differential gear unit is drivingly coupled to the output member by the rotational direction restricting device so as to integrally rotate with the output member, and the third rotating element of the differential gear unit is allowed to rotate by the rotation restricting device, wherein in the split mode, the torque of the input member is transmitted to the output member while the torque is distributed to the first rotating electrical machine.

4. The hybrid drive device according to claim 1, further comprising:
a first electric forward travel mode that is implemented in a state in which the output member rotates in the positive direction relative to the fourth rotating element of the differential gear unit, wherein in the first electric forward travel mode, only the second rotating electrical machine outputs torque among the internal combustion engine, the first rotating electrical machine, and the second rotating electrical machine, and the torque and rotation of the second rotating electrical machine in the positive direction are transmitted to the output member.

5. The hybrid drive device according to claim 1, further comprising:
a first electric rearward travel mode that is implemented in a state in which the third rotating element of the differential gear unit is allowed to rotate by the rotation restricting device, and the fourth rotating element of the differential gear unit is drivingly coupled to the output member by the rotation restricting device so as to integrally rotate with the output member, wherein in the first electric rearward travel mode, only the second rotating electrical machine outputs torque among the internal combustion engine, the first rotating electrical machine, and the second rotating electrical machine, and the torque and rotation of the second rotating electrical machine in the negative direction are transmitted to the output member.

6. The hybrid drive device according to claim 1, further comprising:
a second rotational direction restricting device that is provided between the non-rotating member and the input member, and restricts rotation of the input member so that the input member is allowed to rotate only in the positive direction relative to the non-rotating member, with the rotational direction restricting device serving as a first rotational direction restricting device; and
a second electric travel mode that is implemented in a state in which the third rotating element of the differential gear unit is allowed to rotate by the rotation restricting device, the fourth rotating element of the differential gear unit is drivingly coupled to the output member by the first rotational direction restricting device so as to integrally rotate with the output member, and the input member is fixed to the non-rotating member by the second rotational direction restricting device, wherein in the second electric travel mode, torque and rotation of the first rotating electrical machine are reversed in direction and transmitted to the output member, and torque and rotation of the second rotating electrical machine are transmitted to the output member.

7. The hybrid drive device according to claim 1, further comprising:
a second rotation direction restricting device that is provided between the non-rotating member and the input member, and restricts rotation of the input member so that the input member is allowed to rotate only in the positive direction relative to the non-rotating member, with the rotational direction restricting device serving as a first rotational direction restricting device.

8. The hybrid drive device according to claim 1, wherein
the rotation restricting device is a two-way clutch that is provided between the non-rotating member and the third rotating element of the differential gear unit, and includes, as switchable states, at least three states from: a state in which the third rotating element of the differential gear unit is allowed to rotate in both of the directions relative to the non-rotating member; a state in which the rotation of the third rotating element of the differential gear unit is restricted so that the third rotating element is allowed to rotate only in the positive direction relative to the non-rotating member; a state in which the rotation of the third rotating element of the differential gear unit is restricted so that the third rotating element is allowed to rotate only in the negative direction relative to the non-rotating member; and a state in which the rotation of the third rotating element of the differential gear unit is restricted so that the third rotating element is restricted from rotating in both of the directions relative to the non-rotating member so as to stop the rotation of the third rotating element.

9. The hybrid drive device according to claim 2, further comprising:
a split mode that is implemented in a state in which the fourth rotating element of the differential gear unit is drivingly coupled to the output member by the rotational direction restricting device so as to integrally rotate with the output member, and the third rotating element of the differential gear unit is allowed to rotate by the rotation restricting device, wherein in the split mode, the torque of the input member is transmitted to the output member while the torque is distributed to the first rotating electrical machine.

10. The hybrid drive device according to claim 9, further comprising:
a first electric forward travel mode that is implemented in a state in which the output member rotates in the positive direction relative to the fourth rotating element of the differential gear unit, wherein in the first electric forward travel mode, only the second rotating electrical machine outputs torque among the internal combustion engine, the first rotating electrical machine, and the second rotating electrical machine, and the torque and rotation of the second rotating electrical machine in the positive direction are transmitted to the output member.

11. The hybrid drive device according to claim 10, further comprising:
a first electric rearward travel mode that is implemented in a state in which the third rotating element of the differential gear unit is allowed to rotate by the rotation restricting device, and the fourth rotating element of the differential gear unit is drivingly coupled to the output member by the rotation restricting device so as to integrally rotate with the output member, wherein in the first electric rearward travel mode, only the second rotating electrical machine outputs torque among the internal combustion engine, the first rotating electrical machine, and the second rotating electrical machine, and the torque and rotation of the second rotating electrical machine in the negative direction are transmitted to the output member.

12. The hybrid drive device according to claim 11, further comprising:
a second rotational direction restricting device that is provided between the non-rotating member and the input member, and restricts rotation of the input member so that the input member is allowed to rotate only in the positive direction relative to the non-rotating member, with the rotational direction restricting device serving as a first rotational direction restricting device; and
a second electric travel mode that is implemented in a state in which the third rotating element of the differential gear unit is allowed to rotate by the rotation restricting device, the fourth rotating element of the differential gear unit is drivingly coupled to the output member by the first rotational direction restricting device so as to integrally rotate with the output member, and the input member is fixed to the non-rotating member by the second rotational direction restricting device, wherein in the second electric travel mode, torque and rotation of the first rotating electrical machine are reversed in direction and transmitted to the output member, and torque and rotation of the second rotating electrical machine are transmitted to the output member.

13. The hybrid drive device according to claim 12, further comprising:
a second rotation direction restricting device that is provided between the non-rotating member and the input member, and restricts rotation of the input member so that the input member is allowed to rotate only in the positive direction relative to the non-rotating member, with the rotational direction restricting device serving as a first rotational direction restricting device.

14. The hybrid drive device according to claim 13, wherein
the rotation restricting device is a two-way clutch that is provided between the non-rotating member and the third rotating element of the differential gear unit, and includes, as switchable states, at least three states from: a state in which the third rotating element of the differential gear unit is allowed to rotate in both of the directions relative to the non-rotating member; a state in which the rotation of the third rotating element of the differential gear unit is restricted so that the third rotating element is allowed to rotate only in the positive direction relative to the non-rotating member; a state in which the rotation of the third rotating element of the differential gear unit is restricted so that the third rotating element is allowed to rotate only in the negative direction relative to the non-rotating member; and a state in which the rotation of the third rotating element of the differential gear unit is restricted so that the third rotating element is restricted from rotating in both of the directions relative to the non-rotating member so as to stop the rotation of the third rotating element.

15. The hybrid drive device according to claim 2, further comprising:
a first electric forward travel mode that is implemented in a state in which the output member rotates in the positive direction relative to the fourth rotating element of the differential gear unit, wherein in the first electric forward travel mode, only the second rotating electrical machine outputs torque among the internal combustion engine, the first rotating electrical machine, and the second rotating electrical machine, and the torque and rotation of the second rotating electrical machine in the positive direction are transmitted to the output member.

16. The hybrid drive device according to claim 2, further comprising:
a first electric rearward travel mode that is implemented in a state in which the third rotating element of the differential gear unit is allowed to rotate by the rotation restricting device, and the fourth rotating element of the differential gear unit is drivingly coupled to the output member by the rotation restricting device so as to integrally rotate with the output member, wherein in the first electric rearward travel mode, only the second rotating electrical machine outputs torque among the internal combustion engine, the first rotating electrical machine, and the second rotating electrical machine, and the torque and rotation of the second rotating electrical machine in the negative direction are transmitted to the output member.

17. The hybrid drive device according to claim 2, further comprising:
a second rotational direction restricting device that is provided between the non-rotating member and the input member, and restricts rotation of the input member so that the input member is allowed to rotate only in the positive direction relative to the non-rotating member, with the rotational direction restricting device serving as a first rotational direction restricting device; and
a second electric travel mode that is implemented in a state in which the third rotating element of the differential gear unit is allowed to rotate by the rotation restricting device, the fourth rotating element of the differential gear unit is drivingly coupled to the output member by the first rotational direction restricting device so as to integrally rotate with the output member, and the input member is fixed to the non-rotating member by the second rotational direction restricting device, wherein in the second electric travel mode, torque and rotation of the first rotating electrical machine are reversed in direction and transmitted to the output member, and torque and rotation of the second rotating electrical machine are transmitted to the output member.

18. The hybrid drive device according to claim 3, further comprising:
a first electric forward travel mode that is implemented in a state in which the output member rotates in the positive direction relative to the fourth rotating element of the differential gear unit, wherein in the first electric forward travel mode, only the second rotating electrical machine outputs torque among the internal combustion engine, the first rotating electrical machine, and the second rotating electrical machine, and the torque and rotation of the second rotating electrical machine in the positive direction are transmitted to the output member.

19. The hybrid drive device according to claim 3, further comprising:
a first electric rearward travel mode that is implemented in a state in which the third rotating element of the differential gear unit is allowed to rotate by the rotation restricting device, and the fourth rotating element of the differential gear unit is drivingly coupled to the output member by the rotation restricting device so as to integrally rotate with the output member, wherein in the first electric rearward travel mode, only the second rotating electrical machine outputs torque among the internal combustion engine, the first rotating electrical machine, and the second rotating electrical machine, and the torque and rotation of the second rotating electrical machine in the negative direction are transmitted to the output member.

20. The hybrid drive device according to claim 3, further comprising:
a second rotational direction restricting device that is provided between the non-rotating member and the input member, and restricts rotation of the input member so that the input member is allowed to rotate only in the positive direction relative to the non-rotating member, with the rotational direction restricting device serving as a first rotational direction restricting device; and
a second electric travel mode that is implemented in a state in which the third rotating element of the differential gear unit is allowed to rotate by the rotation restricting device, the fourth rotating element of the differential gear unit is drivingly coupled to the output member by the first rotational direction restricting device so as to integrally rotate with the output member, and the input member is fixed to the non-rotating member by the second rotational direction restricting device, wherein in the second electric travel mode, torque and rotation of the first rotating electrical machine are reversed in direction and transmitted to the output member, and torque and rotation of the second rotating electrical machine are transmitted to the output member.
